(19) United States
(12) Patent Application Publication
(10) Pub. No.: US 2013/0176208 A1
(43) Pub. Date: Jul. 11, 2013

(54) ELECTRONIC EQUIPMENT

(71) Applicant: KYOCERA Corporation, Kyoto-shi (JP)

(72) Inventors: Nao TANAKA, Osaka (JP); Keisuke NAGATA, Kobe-shi (JP); Yoshinori KIDA, Osaka (JP)

(73) Assignee: KYOCERA CORPORATION, Kyoto-shi (JP)

(21) Appl. No.: 13/733,501

(22) Filed: Jan. 3, 2013

(30) Foreign Application Priority Data
Jan. 6, 2012 (JP) 2012-001114

(51) Int. Cl. G06F 3/01

(52) U.S. Cl. CPC G06F 3/013
USPC 345/156

(57) ABSTRACT

A mobile phone which is an example of electronic equipment includes an infrared camera and an infrared LED. The infrared camera is arranged above a display and the infrared LED is arranged below the display. A user, by an eye-controlled input, designates a button image or a predetermined region on a screen. When a line of sight is to be detected, an infrared ray (infrared light) emitted from the infrared LED arranged below the display is irradiated to a lower portion of a pupil. Accordingly, even in a state that the user slightly closes his/her eyelid, the pupil and a reflected light of the infrared light can be imaged.

### CROSS REFERENCE OF RELATED APPLICATION

The disclosure of Japanese Patent Application No. 2012-1114 is incorporated herein by reference.

### BACKGROUND OF THE INVENTION

1. Field of the Invention

The present invention relates to electronic equipment, and more specifically, electronic equipment provided with a display, for example.

2. Description of the Related Art

An example of a related art is disclosed in Japanese Patent Application Laying-Open No. 2003-196017 [G06F 3/033, G06F 3/00, G06T 1/00, G06T 7/60] (document 1) laid-open on Jul. 11, 2003. A data input device of this document 1 displays an input data group of a menu or a keyboard on a display, images an eye portion of a user of the device with a camera, determines a direction of a line of sight of the user in the imaged image, determines input data located in the direction of the line of sight, and outputs determined input data to external equipment, etc.

Another example of a related art is disclosed in Japanese Patent Application Laying-Open No. H9-212287 [G06F 3/033] (Document 2) laid-open on Aug. 15, 1997. An eye point input device of this document 2 performs an inquiry for a sign of a character, numeral, symbol or the like based on a positional data of an eye of an operator being sent from a camera, detects a sign onto which the operator puts his/her eye point, and when it is determined that a detected sign is fixed for a predetermined time period set in advance, outputs the sign to an input circuit.

A further example of a related art is disclosed in Japanese Patent Application Laying-Open No. 2003-150306 [G06F 3/033] (Document 3) laid-open on May 23, 2003. An information display device of this document 3 presumes a gaze point based on a direction of a line of sight if a user performs a selection by his/her line of sight, estimates predetermined information, commodity, etc. based on the presumed direction of the line of sight and displays the information, commodity, etc. being a selection target.

A still further example of a related art is disclosed in Japanese Patent Application Laying-Open No. 2000-20196 [G06F 3/00, G06F 3/033] (Document 4) laid-open on Jan. 21, 2000. In an eye-controlled input device of this document 4, a part of a plurality of kinds of character groups is displayed in a character area, and a character is selected by an eye cursor indicating a position of a line of sight of an observer and the character is input.

The other example of a related art is disclosed in Japanese Patent Application Laying-Open No. H9-204260 [G06F 3/033] (Document 5) laid-open on Aug. 5, 1997. A data input device of this document 5 detects a position of a pupil viewing a part of a display, calculates coordinates on the display corresponding to the detected position, and displays a cursor at a position of the coordinates on the display.

In the above-described eye-controlled input device, there is a tendency that a device becomes larger in proportion to a distance between a sensor and an eye ball. Accordingly, on the assumption that such an eye-controlled input device is incorporated in relatively small electronic equipment such as a mobile terminal, the related arts respectively described in the documents 1 to 4 are not adequate because the device is relatively large. Furthermore, in the related art described in the document 5, a cursor displayed on a display is moved based on an imaged image that a pupil of a user who closes his/her eye to a window such as a finder, and therefore, it is possible to detect a line of sight only in a restricted using situation that the user watches the display through the window. That is, in a case that an eye and a device are separate from each other, there is a possibility that a line of sight cannot be correctly detected.

### SUMMARY OF THE INVENTION

Therefore, it is a primary object of the present invention to provide novel electronic equipment.

Another object of the present invention is to provide electronic equipment capable of increasing a recognition rate of an eye-controlled input.

An aspect according to the present invention is electronic equipment provided with a display portion, comprising: an infrared light detecting portion which is arranged above the display portion and detects an infrared light; and an infrared light output portion which is arranged below the display portion.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an appearance view showing a mobile phone of an embodiment according to the present invention.

FIG. 2 is a view showing electrical structure of the mobile phone shown in FIG. 1.

FIG. 3 is a view showing examples of a lock screen of a security lock, which is displayed on a display shown in FIG. 1.

FIG. 4 is a view showing examples of an application selecting screen which is displayed on the display shown in FIG. 1.

FIG. 5 is a view showing examples of an electronic book (e-book) displaying screen which is displayed on the display shown in FIG. 1.

FIG. 6 is a view showing examples of an alarm screen of an alarm clock and a time displaying screen, which are displayed on the display shown in FIG. 1.

FIG. 7 is a view showing an example of an incoming call screen which is displayed on the display shown in FIG. 1.

FIG. 8 is a view showing examples of a map displaying screen which is displayed on the display shown in FIG. 1 and operating regions set in the map displaying call screen.

FIG. 9 is a view showing a pupil and a reflected light imaged by an infrared camera in a case that the infrared camera and an infrared LED are arranged separately from each other or a case that the infrared camera and the infrared LED are arranged closely to each other.

FIG. 10 is a view showing a method for detecting an eye vector and a method for detecting a distance between both eyes based on an imaged image in a case that a gaze area on a displaying plane of the display is detected by using an infrared camera and an infrared LED of the mobile phone shown in FIG. 1.

FIG. 11 is a view showing divided areas formed by dividing a displaying area of the display.

FIG. 12 is a view showing positional relationships between the pupil and the reflected light at a timing during a calibration for detecting a gaze area.

FIG. 13 is a view showing an example of a memory map of a RAM shown in FIG. 2.

FIG. 14 is a flowchart showing a lock canceling process (security lock) by the processor shown in FIG. 2.

FIG. 15 is a flowchart showing a gaze area detecting process by the processor shown in FIG. 2.

FIG. 16 is a flowchart showing a part of a performing function determining process by the processor shown in FIG. 2.

FIG. 17 is a flowchart showing another part of the performing function determining process by the processor shown in FIG. 2, following FIG. 16.

FIG. 18 is a flowchart showing a part of alarm processing by the processor shown in FIG. 2.

FIG. 19 is a flowchart showing another part of the alarm processing by the processor shown in FIG. 2, following FIG. 18.

FIG. 20 is a flowchart showing application selecting processing by the processor shown in FIG. 2.

FIG. 21 is a flowchart showing a part of e-book displaying processing by the processor shown in FIG. 2.

FIG. 22 is a flowchart showing another part of the e-book displaying processing by the processor shown in FIG. 2, following FIG. 21.

FIG. 23 is a flowchart showing a part of browsing processing by the processor shown in FIG. 2.

FIG. 24 is a flowchart showing another part of the browsing processing by the processor shown in FIG. 2, following FIG. 23.

FIG. 25 is a flowchart showing a part of incoming call processing by the processor shown in FIG. 2.

FIG. 26 is a flowchart showing another part of the incoming call processing by the processor shown in FIG. 2, following FIG. 25.

FIG. 27 is a view showing an example of a lock screen for key lock, which is displayed on the display shown in FIG. 1.

FIG. 28 is a flowchart showing a lock cancelling process (key lock) by the processor shown in FIG. 2.

FIG. 29 is a flowchart showing a further lock cancelling process (key lock) by the processor shown in FIG. 2.

FIG. 30 is a view showing an example of an alarm screen of a schedule displayed on the display shown in FIG. 1.

FIG. 31 is an appearance view showing another example of a mobile phone.

FIG. 32 is an appearance view showing the other example of a mobile phone.

### DETAILED DESCRIPTION OF THE PREFERRED EMBODIMENTS

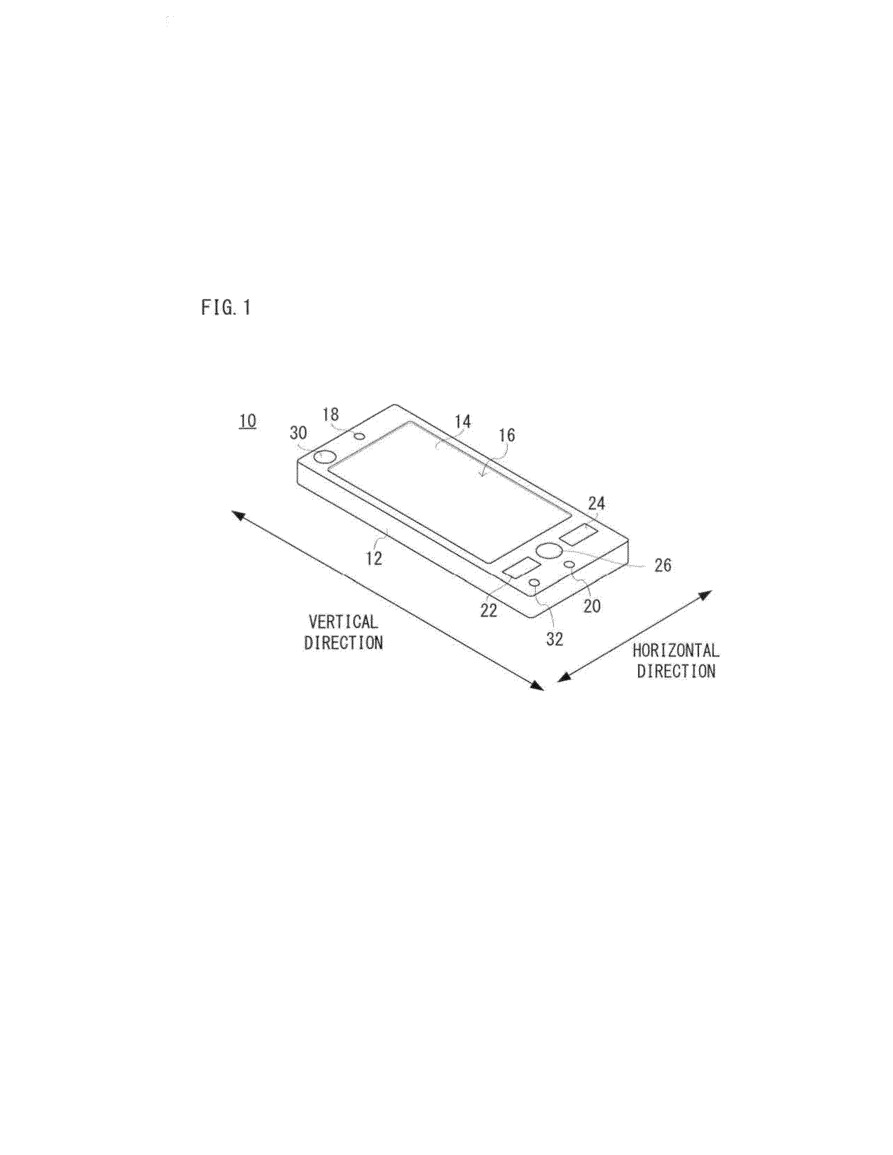

With referring to FIG. 1, a mobile phone 10 of an embodiment according to the present invention is a so-called smartphone, and includes a longitudinal flat rectangular housing 12. A display 14 constituted by a liquid crystal, organic EL or the like, which functions as a display portion, is provided on a main surface (front surface) of the housing 12. A touch panel 16 is provided on the display 14. A speaker 18 is housed in the housing 12 at one end of a longitudinal direction on a side of the front surface, and a microphone 20 is housed at the other end in the longitudinal direction on the side of the front surface. As a hardware key constituting an inputting portion together with the touch panel 16, a call key 22, an end key 24 and a menu key 26 are provided. Furthermore, an infrared camera 30 is provided at a left side of the speaker 18, and an infrared LED 32 is provided at a left side of the microphone 20. The infrared camera 30 and the infrared LED 32 are provided such that an imaging surface of the infrared camera 30 and an light-emitting surface of the infrared LED 32 can be exposed from the housing 12 but the other portions of the infrared camera 30 and the infrared LED 32 are housed within the housing 12.

For example, the user can input a telephone number by making a touch operation on the touch panel 16 with respect to a dial key (not shown) displayed on the display 14, and start a telephone conversation by operating the call key 22. If and when the end key 24 is operated, the telephone conversation can be ended. In addition, by long-depressing the end key 24, it is possible to turn-on/-off power of the mobile phone 10.

If the menu key 26 is operated, a menu screen is displayed on the display 14, and in such a state, by making a touch operation on the touch panel 16 with respect to a software key, a menu icon (both, not shown) or the like being displayed on the display 14, it is possible to select a menu, and to determine such a selection.

In addition, it is pointed out in advance that in this embodiment shown, a description is made on a mobile phone such as a smartphone which is an example of electronic equipment, but the present invention is applicable to various kinds of electronic equipment provided with a display device. An arbitrary mobile terminal such as a feature phone, a tablet terminal, a PDA, etc. comes within examples of other electronic equipment.

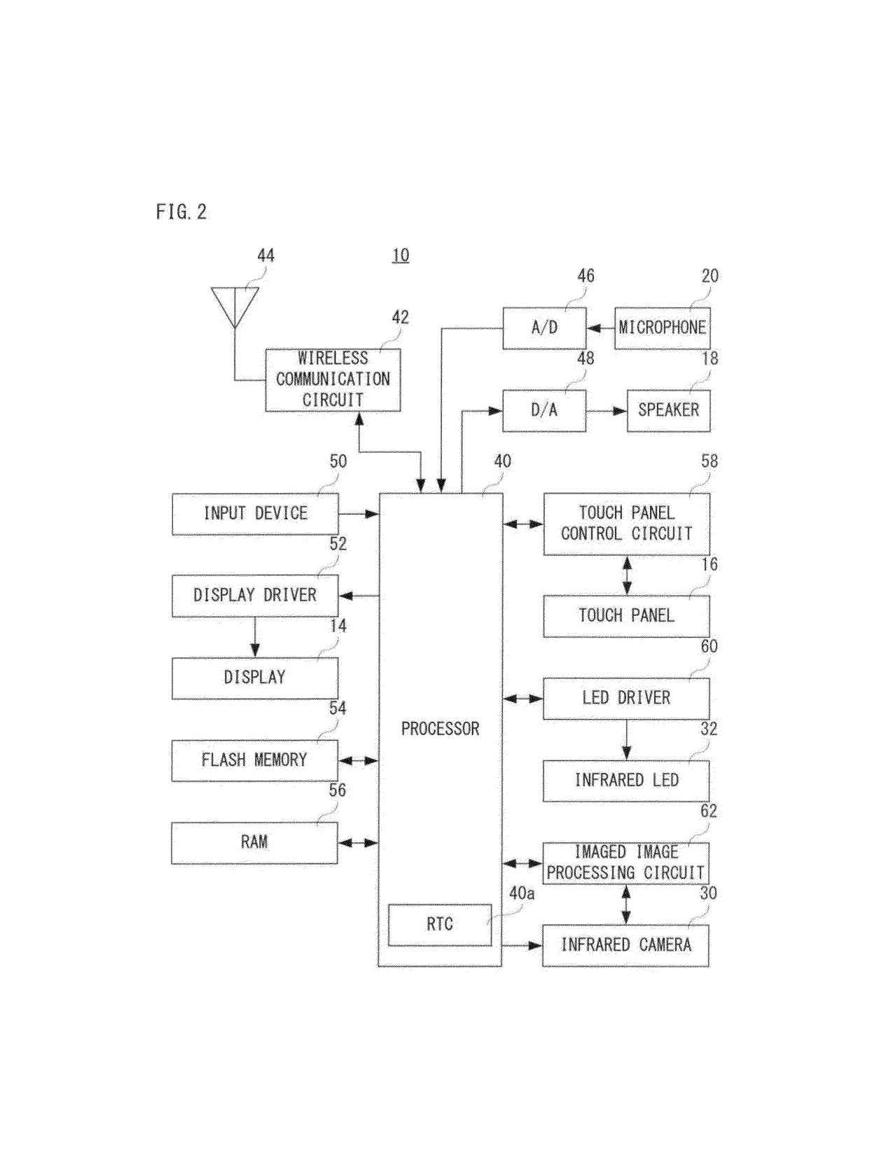

With referring to FIG. 2, the mobile phone 10 of the embodiment shown in FIG. 1 includes a processor 40. The processor 40 is connected with an infrared camera 30, a wireless communication circuit 42, an A/D converter 46, a D/A converter 48, an input device 50, a display driver 52, a flash memory 54, a RAM 56, a touch panel control circuit 58, an LED driver 60, an imaged image processing circuit 62, etc.

The processor 40 is called as a computer or a CPU and in charge of a whole control of the mobile phone 10. An RTC 40a is included in the processor 40, by which a time (including year, month and day) is measured. All or a part of a program set in advance in the flash memory 54 is, in use, developed or loaded into the RAM 56, and the processor 40 performs various kinds of processing in accordance with the program developed in the RAM 56. In addition, the RAM 56 is further used as a working area or buffer area for the processor 40.

The input device 50 includes the hardware keys (22, 24, 26) shown in FIG. 1, and functions as an operating portion or an inputting portion together with the touch panel 16 and the touch panel control circuit 58. Information (key data) of the hardware key operated by the user is input to the processor 40. Hereinafter, an operation with the hardware key is called as “key operation”.

The wireless communication circuit 42 is a circuit for transmitting and receiving a radio wave for a telephone conversation, a mail, etc. via an antenna 44. In this embodiment, the wireless communication circuit 42 is a circuit for performing a wireless communication with a CDMA system. For example, if the user designates an outgoing call (telephone call) using the input device 50, the wireless communication circuit 42 performs a telephone call processing under instructions from the processor 40 and outputs a telephone call signal via the antenna 44. The telephone call signal is transmitted to a telephone at the other end of the line through a base station and a communication network. Then, an incoming call processing is performed in the telephone at the other end of the line, when a communication-capable state is established and the processor 40 performs the telephonic communication processing.

Specifically describing a normal telephonic communication processing, a modulated sound signal sent from a telephone at the other end of the line is received by the antenna 44. The modulated sound signal received is subjected to demodulation processing and decode processing by the wireless communication circuit 42. A received sound signal obtained through such processing is converted into a sound signal by the D/A converter 48 to be output from the speaker 18. On the other hand, a sending sound signal taken-in through the microphone 20 is converted into sound data by the A/D converter 46 to be applied to the processor 40. The sound data is subjected to an encode processing and a modulation processing by the wireless communication circuit 42 under instructions by the processor 40 to be output via the antenna 44. Therefore, the modulated sound signal is transmitted to the telephone at the other end of the line via the base station and the communication network.

When the telephone call signal from a telephone at the other end of the line is received by the antenna 44, the wireless communication circuit 42 notifies the processor 40 of the incoming call. In response thereto, the processor 40 displays on the display 14 sender information (telephone number and so on) described in the incoming call notification by controlling the display driver 52. In addition, the processor 40 outputs from the speaker 18 a ringtone (may be also called as a ringtone melody, a ringtone voice). In other words, incoming call operations are performed.

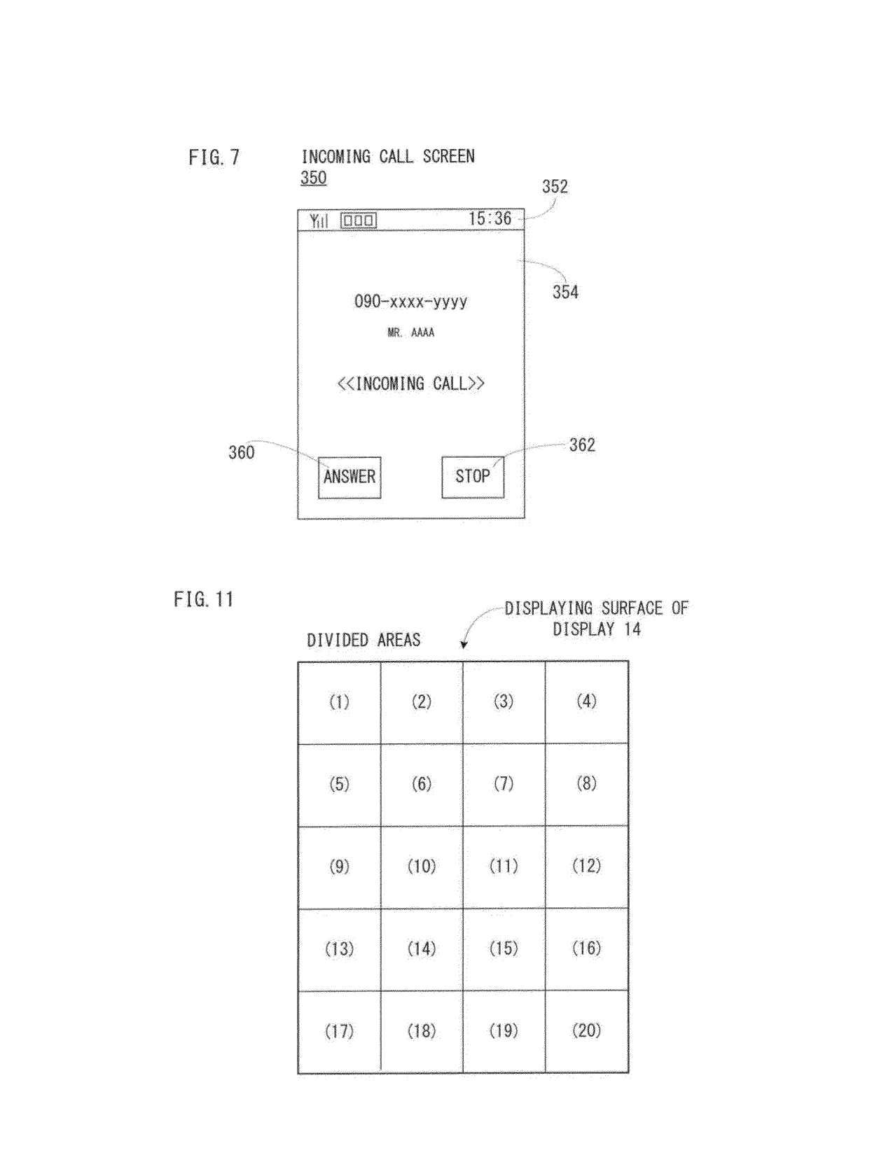

Then, if the user performs an answering operation by using the call key 22 (FIG. 1) included in the input device 50 or an answer button (FIG. 7) displayed on the display 14, the wireless communication circuit 42 performs processing for establishing a communication-capable state under instructions by the processor 40. Furthermore, when the communication-capable state is established, the processor 40 performs the above-described telephone communication processing.

If the telephone communication ending operation is performed by the end key 24 (FIG. 1) included in the input device 50 or an end button displayed on the display 14 after a state is changed to the communication-capable state, the processor 40 transmits a telephone communication ending signal to the telephone at the other end of the line by controlling the wireless communication circuit 42. Then, after the transmission of the telephone communication ending signal, the processor 40 terminates the telephone conversation processing. Furthermore, in a case that the telephone ending signal from the telephone at the other end of the line is received before the telephone conversation ending operation at this end, the processor 40 also terminates the telephone conversation processing. In addition, in a case that the telephone conversation ending signal is received from the mobile communication network not from the telephone at the other end of the line, the processor 40 also terminates the telephone conversation processing.

In addition, the processor 40 adjusts, in response to an operation for adjusting a volume by the user, a sound volume of the sound output from the speaker 18 by controlling an amplification factor of the amplifier connected to the D/A converter 48.

The display driver 52 controls a displaying by the display 14 which is connected to the display driver 40 under instructions by the processor 40. In addition, the display driver 52 includes a video memory temporarily storing image data to be displayed. The display 14 is provided with a backlight which includes a light source of an LED or the like, for example, and the display driver 52 controls, according to the instructions from the processor 40, brightness, light-on/-off of the backlight.

The touch panel 16 shown in FIG. 1 is connected to a touch panel control circuit 58. The touch panel control circuit 58 inputs to the processor 40 a turning-on/-off of the touch panel 16, a touch start signal indicating a start of a touch by the user to the touch panel 16, a touch end signal indicating an end of a touch by the user, and coordinates data (touch coordinates data) indicating a touch position that the user touches. The processor 40 can determine which icon or key is touched by the user based on the coordinates data input from the touch panel control circuit 58. Hereinafter, an operation through the touch panel 16 is called as “touch operation”.

In the embodiment, the touch panel 16 is of an electrostatic capacitance system that detects a change of an electrostatic capacitance between electrodes, which occurs when an object such as a finger is in close to a surface of the touch panel 16, and it is detected that one or more fingers are brought into contact with the touch panel 16, for example. The touch panel control circuit 58 functions as a detecting portion for detecting a touch operation, and, more specifically, detects a touch operation within a touch-effective range of the touch panel 16, and outputs touch coordinates data indicative of a position of the touch operation to the processor 40.

In addition, for a detection system of the touch panel 16, a surface-type electrostatic capacitance system may be adopted, or a resistance film system, an ultrasonic system, an infrared ray system, an electromagnetic induction system or the like may be adopted. Furthermore, a touch operation is not limited to an operation by a finger, may be performed by a touch pen.

An LED driver 60 is connected with an infrared LED 32 shown in FIG. 1. The LED driver 60 switches turning-on/-off (lighting/lighting-out) of the infrared LED 32 based on a control signal from the processor 40.

To an imaged image processing circuit 62, an infrared camera 30 shown in FIG. 1 is connected. The imaged image processing circuit 62 applies image processing to imaged image data from the infrared camera 30, and inputs monochrome image data to the processor 40. The infrared camera 30 performs imaging processing under instructions from the processor 40 to input imaged image data to the imaged image processing circuit 62. The infrared camera 30 is constituted by a color camera using an imaging device such as a CCD or CMOS and an infrared filter, for example. Therefore, if the structure such that the infrared filter can be freely attached or detached is adopted, by removing the infrared filter, it is possible to obtain a color image.

In addition, the above-described wireless communication circuit 42, A/D converter 44 and D/A converter 46 may be included in the processor 40.

In the mobile telephone 10 having such structure, instead of a key operation or a touch operation, it is possible to perform an input or operation by a line of sight (hereinafter, may be called as “eye-controlled operation” or “eye-controlled input”). In the following, with using the drawings, examples of eye-controlled operation will be described. Although a detecting method of a gaze area based on the eye-controlled operation will be described in detail, by the eye-controlled operation, predetermined processing that is set in correspondence to a predetermined region (hereinafter, may be called as “operating region”) designated by a point (a gaze point) that a line of sight and a displaying plane of the display 14 are intersected with each other is performed.

As the predetermined processing, predetermined information is input, a predetermined action (operation) is performed, or a predetermined application is activated, for example. A button image capable of being designated or turned-on by the eye-controlled operation, or a displaying region of a reduced image such as an icon or thumbnail comes under the operating region; however, there is a case that only an operating region is set in an area where no such image is displayed. Furthermore, in this embodiment shown, an area including a gaze point (“divided area” described later) is determined as a gaze area, and it is determined that an operating region overlapped with the gaze area or included in the gaze area is designated by the eye-controlled operation. Therefore, a position where a reduced image such as a button image, icon or thumbnail designated or turned-on by the eye-controlled operation is displayed and a size thereof, and a position and a size of an operating region that is set without relationship with such an image are determined by taking the divided area into account. For example, it is configured not to display a plurality of reduced images in the same divided area, or not to set a plurality of operating area in the same divided area.

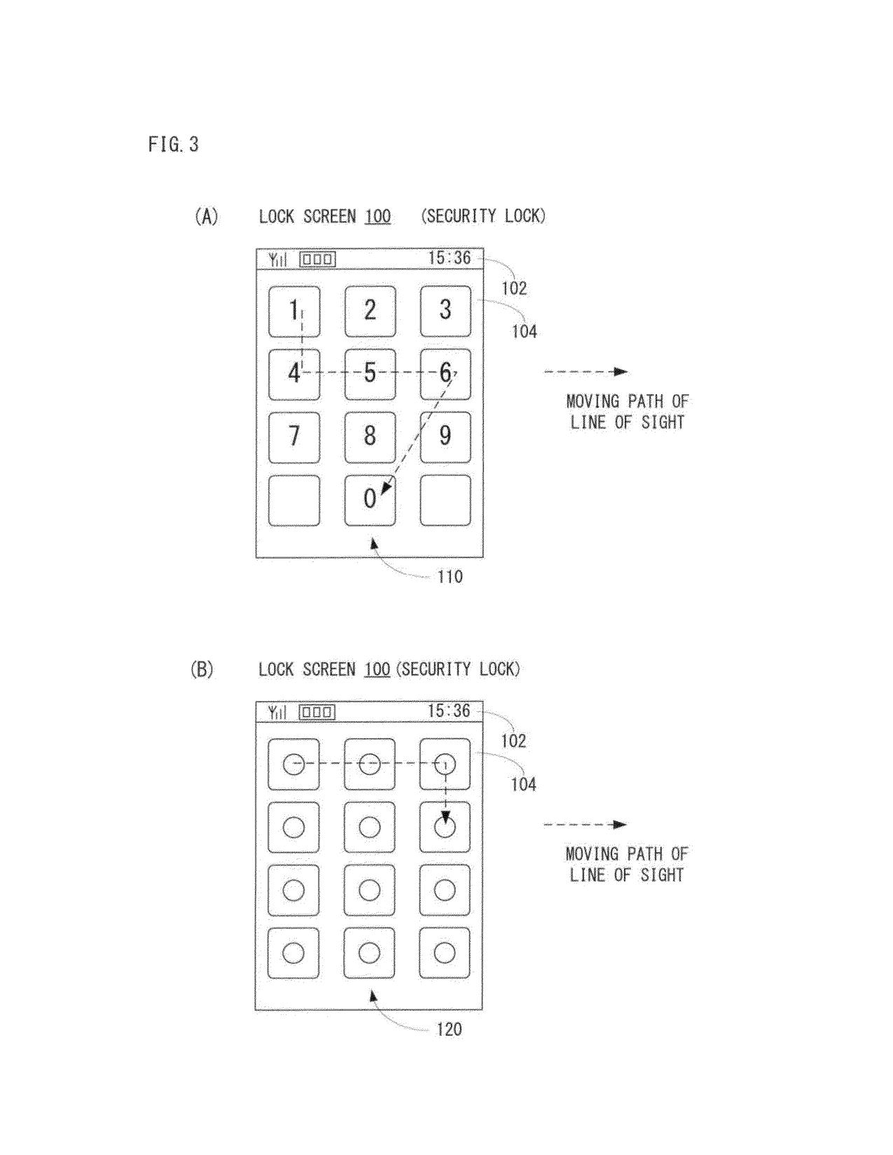

FIG. 3(A) and FIG. 3(B) show examples of a lock screen 100 displayed on the display 14 of the mobile phone 10. Such a lock screen 100 is displayed on the display 14 in starting an operation of the mobile phone 10 or in starting a predetermined function (an address book function and email function) according to a setting by the user. Here, a lock function for security (security lock) is described.

As shown in FIG. 3(A), the lock screen 100 includes a displaying area 102 and a displaying area 104. In the displaying area 102, a strength of radio wave, a residual quantity of battery, a current time, etc. are displayed. This is true for displaying areas 152, 202, 252, 302, 352, 402, 452 and 602 described later. Therefore, a description for each time is omitted. Returning to FIG. 3(A), in the displaying area 104, a plurality of numeral keys (button images) 110 such as a ten-key is displayed.

In the lock screen 100 shown in FIG. 3(A), if and when a secret code number of a predetermined number of digits set in advance by the user is correctly input, the lock screen 100 is put out (non-displayed), and on the display 14, a standby screen or a screen of a desired function is displayed. The input of the secret code number is performed by the eye-controlled operation. Therefore, in a case that such a lock screen 100 is displayed, it is determined that a button image designated based on an intersecting point of a line of sight and a screen is operated. However, as described above, in this embodiment shown, since the gaze area is detected, it is determined that the button image 110 having an operating region overlapped with the gaze area is turned-on (operated).

In a case that a 4-digit numeral “1460” is set as the secret code number, for example, if a line of sight is moved as shown by an arrow mark of a dotted line, it is determined that the button images 110 arranged on a moving path of the line of sight are operated in an order that the line of sight is moved. Therefore, in the example shown in FIG. 3(A), a numeral “145690” is input by the eye-controlled operation. Accordingly, the numeral is not coincident with the set secret code number in not only the number of digits but also numerals.

In a case of the eye-controlled operation, since a position on the screen designated by the line of sight is continuously changed, a button image arranged between two button images is also operated (turned-on). Therefore, in this embodiment shown, even if a numeral not included in the secret code number is input by the eye-controlled operation, if a time period that the secret code number is input by the eye-controlled operation is within a first predetermined time period (30 seconds, for example), and if an alignment order of the numerals is identical, it is determined that a correct secret code number is input.

Therefore, in a case that the numeral “145690” is input by the eye-controlled operation within the first time period, since the input numeral “145690” includes a numeral “1460” of the secret code number in the same order, it is determined that a correct secret code number is input. Then, the lock screen 100 is put out (non-displayed) and an arbitrary screen such as a standby screen becomes to be displayed.

Furthermore, in the lock screen 100 shown in FIG. 3(B), a plurality of button images 120 in each of which a predetermined figure is depicted are displayed in the displaying area 104. In the lock screen 100 of FIG. 3(B), if the eye-controlled operation is performed such that a plurality of button images 120 set in advance by the user are designated in a predetermined order, the lock screen 100 is put out (non-displayed).

A lock cancel is thus implemented by an eye-controlled operation, it is possible to perform a lock cancel by the eye-controlled operation even in a situation that the mobile phone 10 can be held by one hand but both hands cannot be used. Furthermore, since the lock cancel can be performed by a line of sight, operated button images and an order of operation cannot be known by other persons, and therefore, it is possible to increase the security.

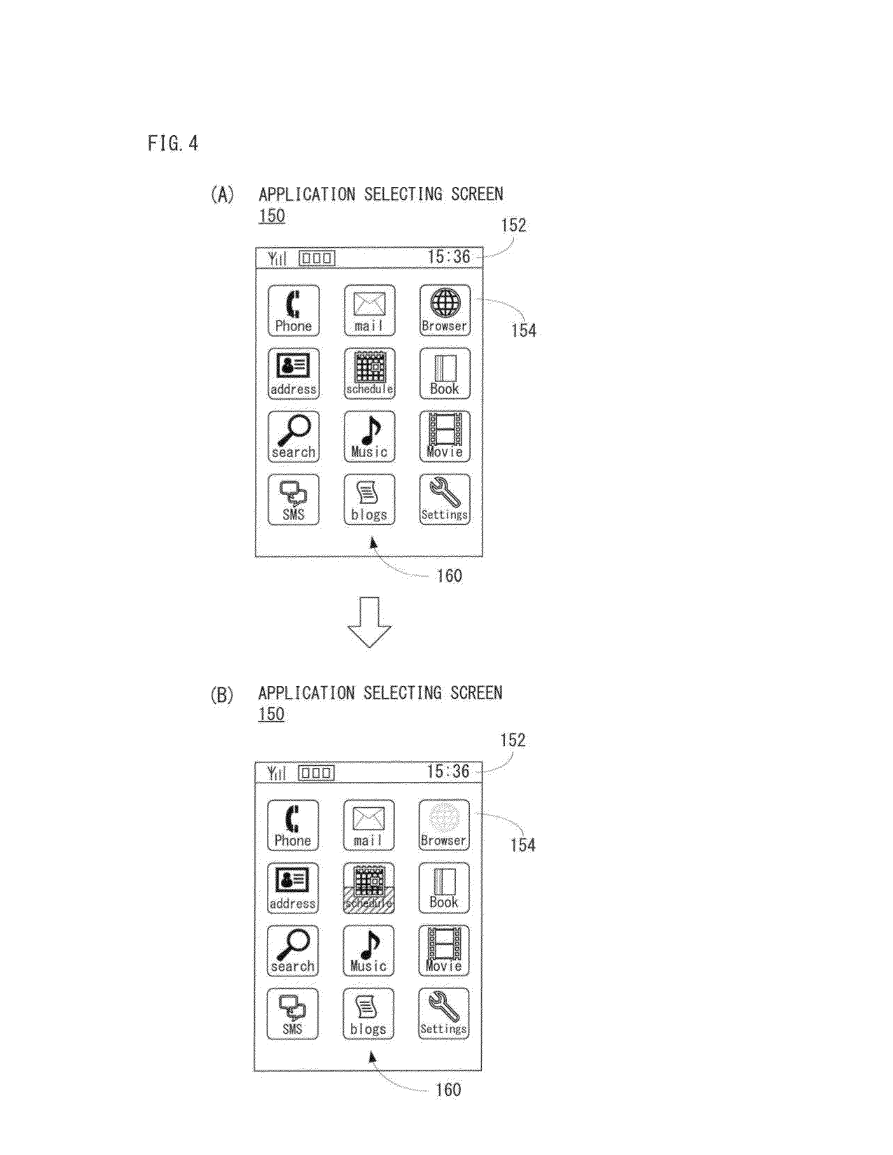

Furthermore, the user can select (execute) an application, select a menu or select an image through an eye-controlled operation. FIG. 4(A) shows an example of a screen (application selecting screen) 150 for selecting an application or function. As shown in FIG. 4(A), the application selecting screen 150 includes a displaying area 152 and a displaying area 154. In the displaying area 154, a plurality of icons 160 for executing (activating) applications or functions installed in the mobile phone 10 are displayed.

In the application selecting screen 150 as shown in FIG. 4(A), for example, the user gazes at an icon 160 for an application or function that the user intends to activate (execute), and when a gazing time (gaze time) reaches or exceeds a second predetermined time period (1-3 seconds, for example), an application or function assigned to the gazed icon 160 is executed (selected).

At that time, in order to notify the user of the icon 160 the user gazes at and its gaze time, the processor 40 linearly or gradually changes a background color of the icon 160 determined that the user gazes at, in accordance with a length of the gaze time. For example, in a case that an icon 160 for a schedule function is gazed at as shown in FIG. 4(B), a background color is changed in accordance with the gaze time. In FIG. 4(B), it is indicated that the background color is changed by applying slant lines to the icon 160. A predetermined amount (predetermined dot width) that the background color is linearly or gradually changed is set such that the color change is ended at a timing that the gaze time becomes equal to the second predetermined time period.

Thus, by changing a background color of an icon 160 according to a gaze time, it is possible to notify the user by a displaying manner (image), a gaze target and a gaze time (or a remaining time to be gazed) or a time until an application or function is started.

Likewise, in a case that a plurality of button images (thumbnails) are displayed, if a desired button image is gazed at, a background color of the button image is changed, and if the gaze time reaches the second predetermined time period, an operation (action) set to the button image is performed.

In this embodiment shown, a background color is changed, but it is not necessary to limit thereto. That is, it is possible to adopt various methods for changing a displaying manner of an icon. For example, an icon being gazed at may be made larger and an icon not gazed at may be made smaller. Furthermore, an icon being gazed may be displayed in rotation. In addition, in a case that a size of an icon is changed, a maximum (largest) size of an icon is determined in advance in accordance with the second predetermined time period and stored in the RAM 56 so that the user can recognize a time lapse of the second predetermined time period by a displaying manner (image). Likewise, in a case that an icon is rotated, a rotation number of an icon is determined in advance in accordance with the second predetermined time period, and stored in the RAM 56.

Furthermore, as a method for changing a color of an icon, a further method may be adopted. For example, an entire background color may be changed to a further color gradually, or a luminance of the background color may be changed gradually.

In addition, instead of a change of a displaying manner of an icon, processing that outside an area where a gazed icon is being displayed, a gaze time is indicated by a numeral or an indicator having a bar a length of which is changed according to a gaze time is displayed, may be performed.

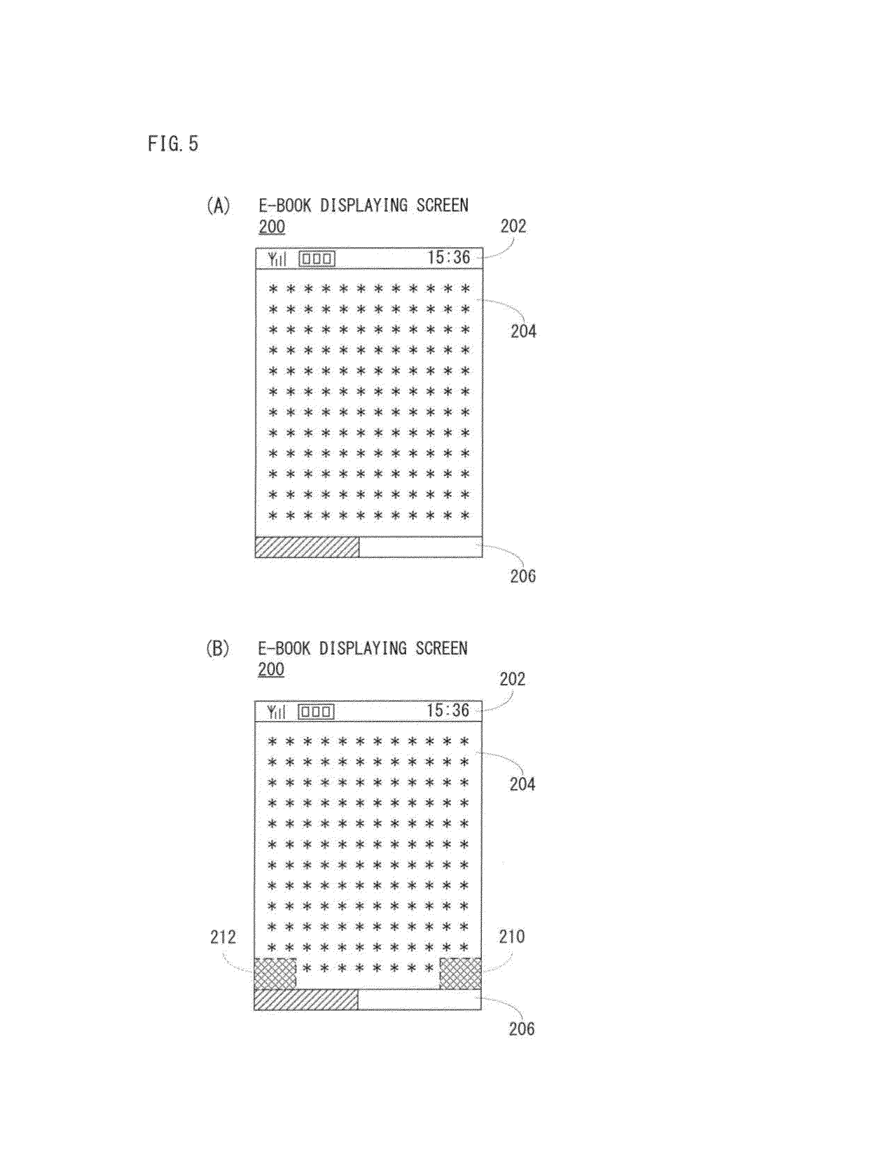

FIG. 5(A) is an example of an e-book displaying screen 200 displayed on the display 14 when an application or function of an e-book is executed. In a case that an icon 160 for an e-book is selected (executed) in an application selecting screen 150, for example, such the e-book displaying screen 200 is displayed.

As shown in FIG. 5(A), the e-book displaying screen 200 includes a displaying area 202, a displaying area 204 and a displaying area 206. In the displaying area 204, a content (page) of an e-book is displayed. Although the content of the e-book is shown by “*” in FIG. 5(A), in fact, characters, images, etc. are displayed. In addition, the displaying area 206 functions as an indicator. Specifically, the displaying area 206 is provided to notify the user of a time (gaze time) that a user is gazing at an operating region.

In this embodiment shown, in a case that the user reads the e-book, the user can turn pages by an eye-controlled operation. For example, as shown in FIG. 5(B), an operating region 210 is formed at a lower right portion of the displaying area 204 and an operating region 212 is formed at a lower left portion of the displaying area 204. In addition, an operation for advancing a page (also called as “page advancing”) is assigned to the operating region 210, and an operation for returning a page (also called as “page returning”) is assigned to the operating region 212. The operating regions 210 and 212 may be made visible for the user by applying a semi-transparent color on a front surface of the e-book, or may be made invisible for the user by not displaying the same.

In the displaying area 206, a gaze time of the operating region 210 or the operating region 212 is indicated by displaying a bar having a color different from a background color. In the e-book displaying screen 200, if and when the gaze time of the operating region 210 or the operating region 212 reaches a third predetermined time period (1-3 seconds, for example), the page advancing or the page returning is performed. In addition, a length of the bar being displayed in the indicator (displaying area 206) is linearly or gradually changed according to the gaze time, and when the gaze time becomes coincident with the third predetermined time period, the bar reaches the right end of the displaying area 206.

Since the indicator is thus provided, the user can know the gaze time of the operating region 210 or the operating region 212 (or a remaining time that the user has to gaze at the operating region until an operation the user intends is performed), or a time until a page is turned, through a change in displaying manner (image).

In the above-described embodiment, the pages of the e-book is advanced or returned on a page-by-page basis, but not limited thereto. For example, further operating regions are formed at an upper right portion and an upper left portion of the displaying area 204, and if the operating region of the upper right portion is continuously gazed for more than the third predetermined time period, the e-book is advanced to the last page or a next chapter, and if the operating region of the upper left is continuously gazed for more than the third predetermined time period, the e-book is returned to the first page of the e-book, the first page of the current chapter or the first page of the previous chapter.

In such a case, when it is detected that the operating region is gazed, or it is detected that the operating region is continuously gazed for a predetermined time period, a page number of an advancing page designation or a returning page designation may be displayed on the display 14. The user can know the page or the page number of the advancing designation or the returning designation by such a displaying.

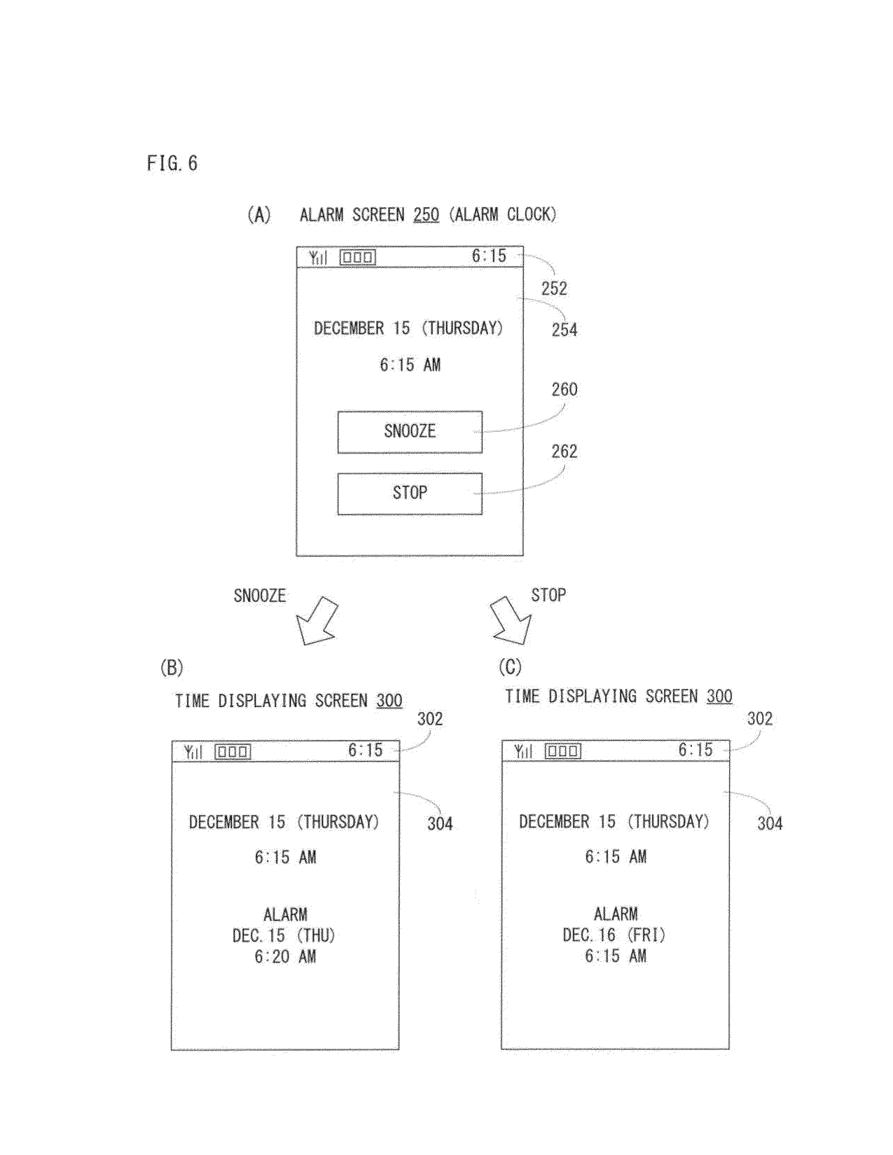

FIG. 6(A) shows an example of an alarm screen 250 displayed on the display 14 in a case that an alarm is ringing (an output of an alarm sound or vibration of the mobile phone 10). As shown in FIG. 6(A), the alarm screen 250 includes a displaying area 252 and a displaying area 254. In the displaying area 254, information of month, day, day of week, current time, etc. is displayed, and a button image 260 and a button image 262 are displayed. The button image 260 is formed to set (on) a so-called snooze function. The button image 262 is formed to stop an alarm.

Accordingly, in a case that the alarm screen 250 is being displayed, according to an eye-controlled operation by the user, if a time (gaze time) that a user gazes at the button image 260 reaches a fourth predetermined time period (1-3 seconds, for example), the button image 260 is turned-on. Then, the snooze function is turned-on, and therefore, an alarm is stopped once and as shown in FIG. 6(B), a time displaying screen 300 in which an alarm time changed by adding a snooze time (5-10 minutes, for example) is set is displayed on the display 14.

In a case that the alarm screen 250 is being displayed, through an eye-controlled operation by the user, if the gaze time of the button image 262 reaches the fourth predetermined time period, the button image 262 is turned-on. Accordingly, the alarm is stopped and as shown in FIG. 6(C), a time displaying screen 300 in which an alarm time for a next alarm is set is displayed on the display 14.

An operation such as stopping an alarm is thus performed by an eye-controlled operation, in a case that an alarm function of the mobile phone 10 is used as an alarm clock, since the user must open his/her eyes, it is possible to suitably carry out a purpose of an alarm clock.

FIG. 7 shows an example of an incoming call screen 350 displayed on the display 14 at a time of an incoming call. As shown in FIG. 7, the incoming call screen 350 includes a displaying area 352 and a displaying area 354. In the displaying area 354, a telephone number of a sending terminal and a name of a sender are displayed, and a message indicates an incoming call is being arrived. A button image 360 is displayed at a lower left portion of the displaying area 354 and a button image 362 is displayed at a lower right portion of the displaying area 354. The button image 360 is formed to answer or reply to the incoming call, and the button image 362 is formed to stop or refuse the incoming call.

Hence, when a time (gaze time) that a user gazes at the button image 360 reaches a fifth predetermined time period (1-3 seconds, for example), the button image 360 is turned-on, and the mobile phone 10 answers the incoming call. That is, as described above, incoming call processing is performed to start normal telephone conversation processing. If the gaze time of the button image 362 exceeds the fifth predetermined time period, the button image 362 is turned-on, and the incoming call is stopped.

Since an operation for an incoming call can be thus performed through an eye-controlled operation, even in a situation that the mobile phone 10 is held by one hand but another hand is not usable, it is possible to answer to the incoming call or stop the incoming call.

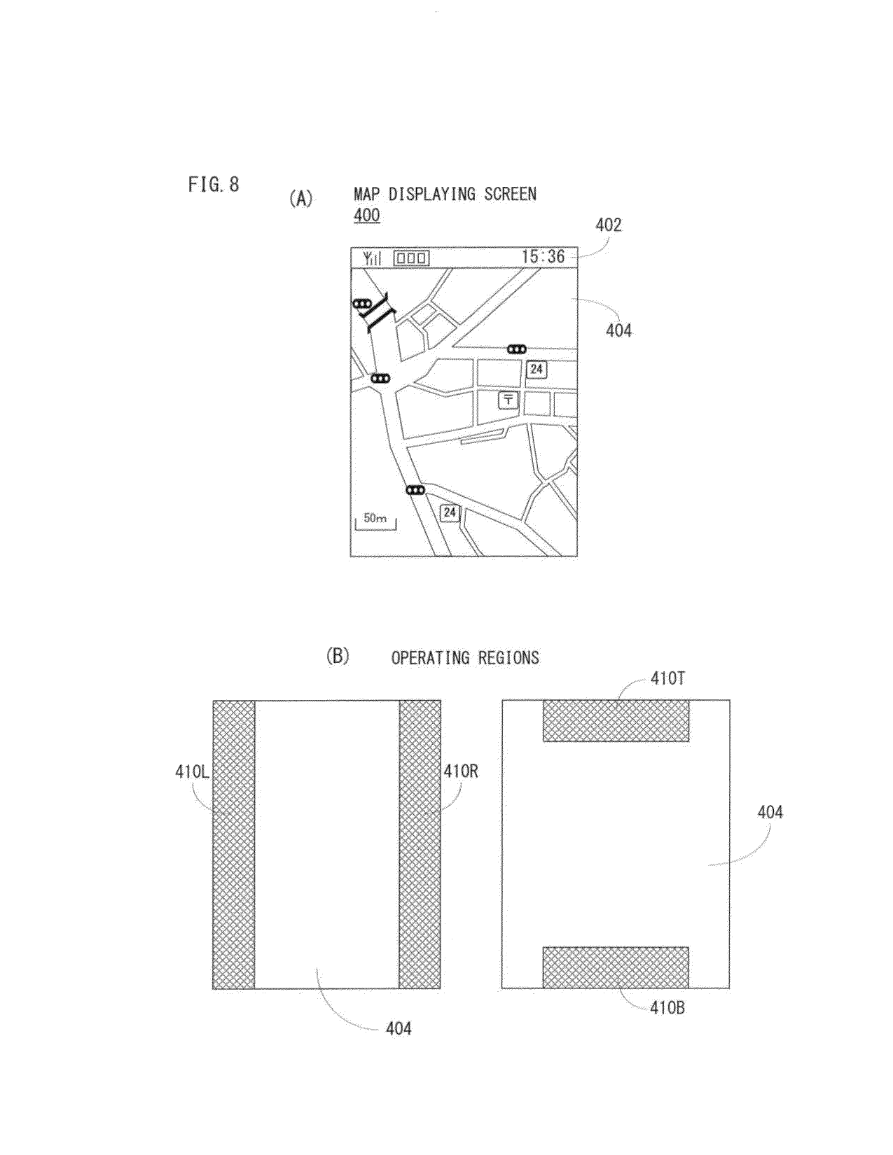

FIG. 8(A) is an example of a map displaying screen 400 displayed on the display 14. The map displaying screen 400 includes a displaying area 402 and a displaying area 404. In the displaying area 404, a map is displayed. A map of a location specified by an address by performing a browsing function by a user may be displayed in the displaying area 404.

Furthermore, in a case that the browsing function is being performed, as shown in FIG. 8(B), four operating regions 410L, 410R, 410T and 410B are set in the screen. The operating region 410L is set at a left end portion of the displaying area 404, to which an operation for scrolling a screen in the rightward direction is assigned. The operating region 410R is set at a right end portion of the displaying area 404, to which an operation for scrolling a screen in the leftward direction is assigned. The operating region 410T is set at an upper end portion of the displaying area 404, to which an operation for scrolling a screen in the downward direction is assigned. The operating region 410B is set at a lower end portion of the displaying area 404, to which an operation for scrolling a screen in the upward direction is assigned.

Accordingly, if a time (gaze time) that a user gazes at a left end of the screen reaches a sixth predetermined time period (1-3 seconds, for example), the screen is scrolled in the rightward direction at a predetermined amount. If a time that the user gazes at a right end of the screen reaches the sixth predetermined time period, the screen is scrolled at a predetermined amount in the leftward direction. Furthermore, if a time that a user gazes at an upper end of the screen reaches a sixth predetermined time period, the screen is scrolled in the downward direction at a predetermined amount. A time that the user gazes at a downward end of the screen reaches the sixth predetermined time period, the screen is scrolled at a predetermined amount in the upward direction.

In addition, in an example shown in FIG. 8(B), lengths of the operating regions 410T and 410B are set shorter such that the left and right operating regions 410L and 410R do not overlap with the upper or lower operating regions 410T and 410B, but the lengths of the left and right operating regions 410L and 410R may be set shorter. Furthermore, the left and right operating regions 410L and 410R and the upper and lower operating regions 410T and 410B are set so as to be overlapped with each other at four corners, respectively, and to each overlapped region, an operation for scrolling a screen in an oblique direction at a predetermined amount may be assigned. Furthermore, only the left and right operating regions 410L and 410R or the upper and lower operating regions 410T and 410B may be provided.

Since a screen can be thus scrolled through an eye-controlled operation, even in a situation that a mobile phone 10 is held by one hand but another hand is unusable, a displaying content such as a map larger than a size of a screen of the display 14 can be confirmed.

In addition, as far as a situation that the scroll is performed by an eye-controlled operation is concerned, not limited to the browsing function, in a case that other applications or functions are to be performed, by setting the operating regions (410L, 410R, 410T and 410B) as shown in FIG. 8(B), a screen may be scrolled by an eye-controlled operation.

Next, a detecting method of a gaze area by a line of sight according to the embodiment will be described. As shown in FIG. 1, the infrared camera 30 and the infrared LED 32 are arranged apart from each other with a certain distance in vertical direction of the mobile phone 10. For example, the infrared camera 30 and the infrared LED 32 are arranged in a manner that a center of an imaging surface of the infrared camera 30 and a center of a light emitting surface of the infrared LED 32 are aligned on a straight line. Furthermore, as shown in FIG. 1, the infrared camera 30 is arranged above the display 14 and the infrared LED 32 is arranged below the display 14. A reason why such an arrangement is adopted is as follow.

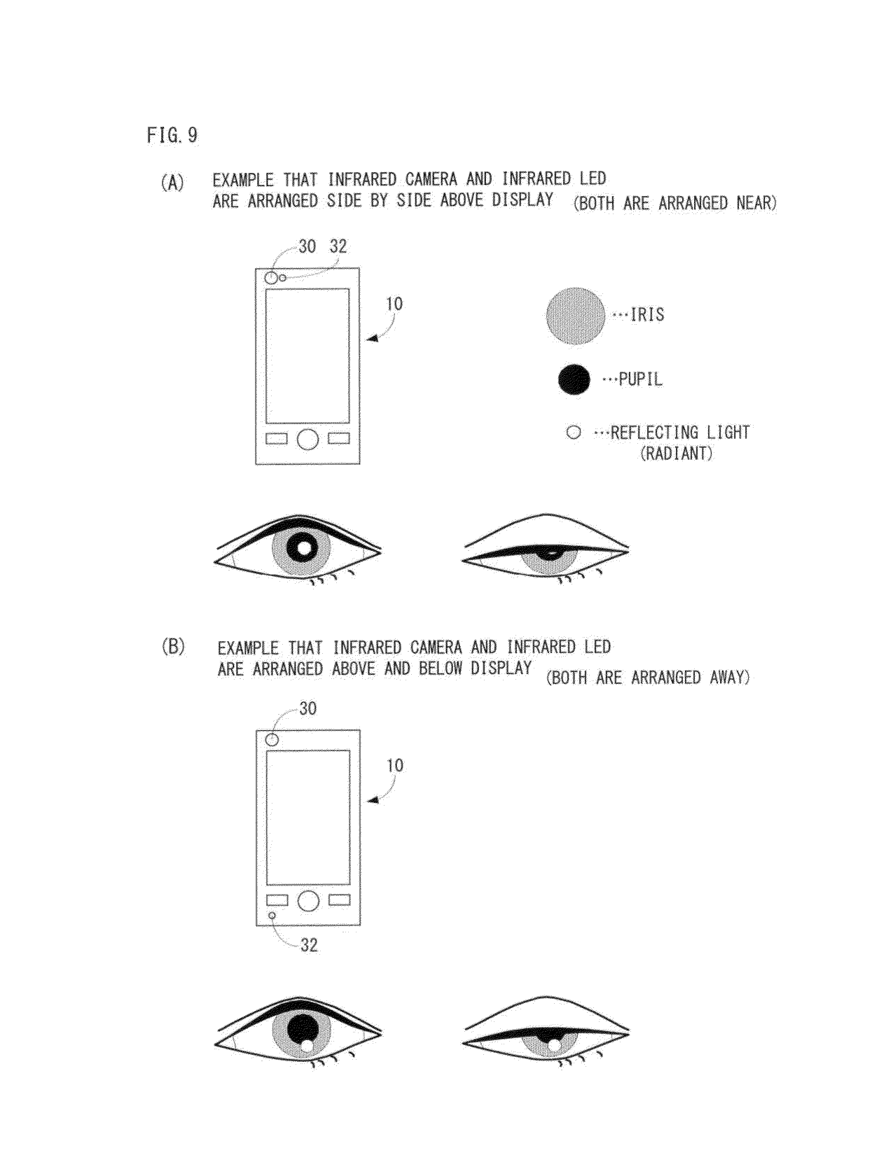

As shown at an upper side of FIG. 9(A), in a case that the infrared camera 30 and the infrared LED 32 are arranged (closely arranged) above the display 14 side-by-side, as shown at a lower left side of FIG. 9(A), when an eyelid is opened relatively larger, it is possible to image a reflecting light (a radiant) of an infrared light irradiated from the infrared LED 32 by the infrared camera 30; however, as shown at a lower right side in FIG. 9(A), when the eyelid is slightly closed, there is an occasion that the infrared light is blocked by the eyelid, and thus, the infrared camera 30 cannot image the reflecting light. In the mobile phone 10 as of this embodiment, there is a case that the mobile phone 10 is used with a situation that a user slightly turns his/her face downward, and therefore, it is assumed that the reflecting light cannot be imaged because the infrared light is blocked by the eyelid.

Therefore, as also shown at an upper side of FIG. 9(B), the infrared camera 30 and the infrared LED 32 are arranged above and below the display 14, respectively. In such a case, the infrared light is irradiated to a lower portion than a center of the pupil. Accordingly, as shown at a lower left side in FIG. 9(B), of course, in a case that the user opens the eyelid relatively larger, even in a case that the user slightly closes the eyelid as shown at a lower right side in FIG. 9(B), it is possible to surely image the reflecting light of the infrared light. Thus, as described above, when (a face of) the user faces straight the mobile phone 10, the infrared camera 30 and the infrared LED 32 are arranged such that the former becomes an upper side and the latter becomes a lower side, respectively.

In addition, a distance between the infrared camera 30 and the infrared LED 32 is determined based on a distance between a face of the user and the mobile phone 10 (a surface of a housing or a displaying plance of the display 14) at a time that the user uses the mobile phone 10, a size of the mobile phone 10 and so on.

In a case that the gaze area is to be detected, in an imaged image that the infrared camera 30 images, a pupil and a reflecting light of the infrared light are detected by the processor 40. A method for detecting a pupil and a reflecting light of the infrared light in the imaged image is well-known, and not essential for this embodiment shown, and therefore, a description thereof is omitted here.

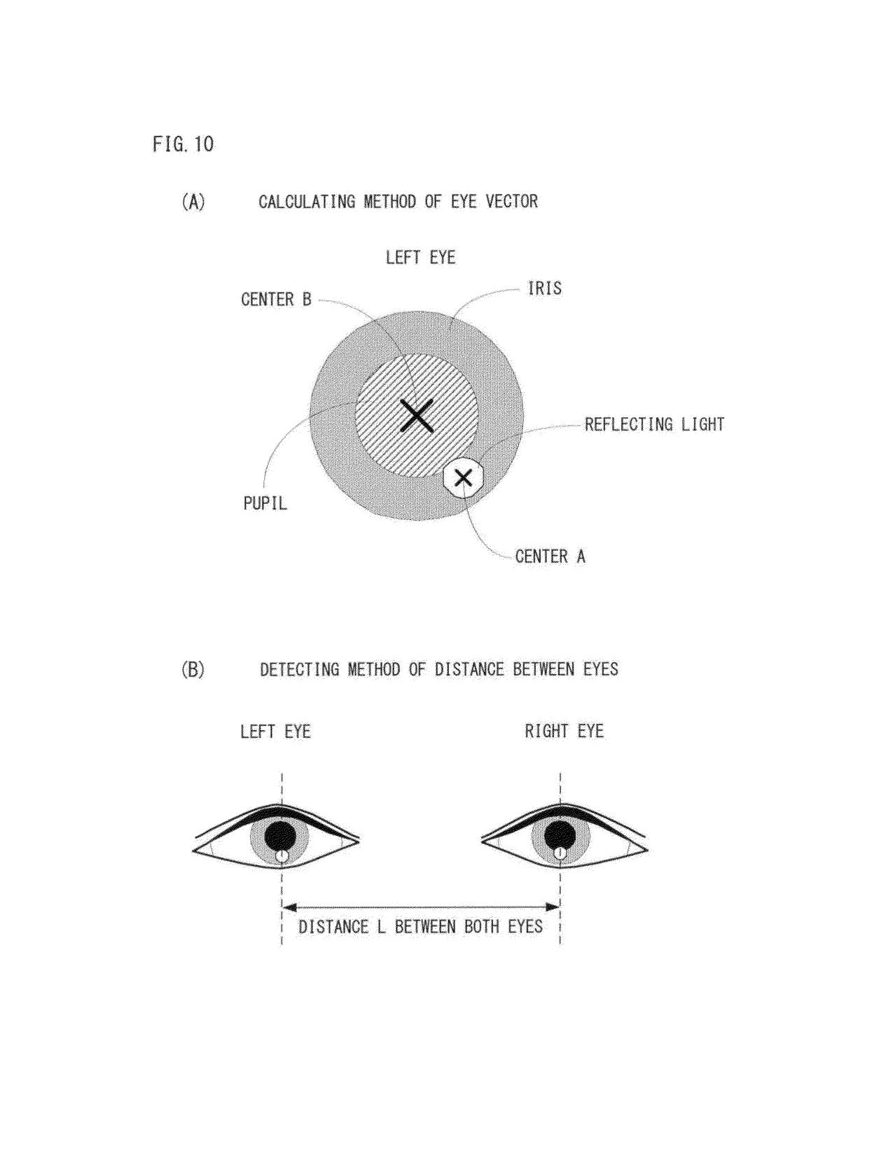

When the processor 40 detects the pupil and the reflecting light in the imaged image, then, the processor 40 detects a direction of a line of sight (eye vector). Specifically, a vector from a position of the reflecting light to a position of the pupil in a two dimensional image imaged by the infrared camera 30 is detected. That is, a vector from a center A to a center B is an eye vector as shown in FIG. 10(A). A coordinates system in the infrared camera 30 is determined in advance, and by using such a coordinates system, the eye vector is calculated. By detecting what divided area the eye vector thus detected designates on the displaying surface, a gaze area of the user is determined.

As shown in FIG. 11, a displaying surface of the display 14 is divided by a grid into a plurality of areas. In this embodiment shown, the display 14 is divided into twenty (20) (5 columns×4 rows) areas. But, this is a mere example and it is possible to arbitrarily set the number of the divided areas and a shape thereof. Respective divided areas are identifiably managed to which identification information indicated by numerals (1)-(20) are assigned respectively. In order to manage positions and shapes of the respective divided areas, for each of the identification information (1)-(20), information of coordinates indicative of a position and a shape of each divided area is stored. In this embodiment shown, the divided area is defined by a rectangular, and therefore, coordinates of the diagonal apexes are stored as the coordinates information, whereby the position and the size of each divided area can be known.

In addition, in a case an eye-controlled operation is to be performed, at first, a calibration that is calibrating processing performed in starting the eye-controlled operation is executed; however, it is not necessary to perform a calibration at every time that the eye-controlled operation is started, a calibration may be executed at a time that the use of the mobile phone 10 is started or may be performed in response to a designation by the user, or a calibration may be performed at every predetermined time.

An eye vector in a case that the user gazes at each divided area is detected in advance through a calibration, and in correspondence to an identification information of the divided area, respective detected eye vectors are stored as reference eye vectors (reference victors N (N=1, 2, - - -, 20). In the calibration, for example, an eye vector is sequentially detected from the divided area in the uppermost column and in the column, an eye vector is sequentially detected from the left end divided area. Therefore, by detecting a reference vector N, most closely related to an eye vector of the user that is detected when an eye-controlled operation is actually performed, the divided area stored in correspondence to the most approximate reference vector N is determined as a gaze area.

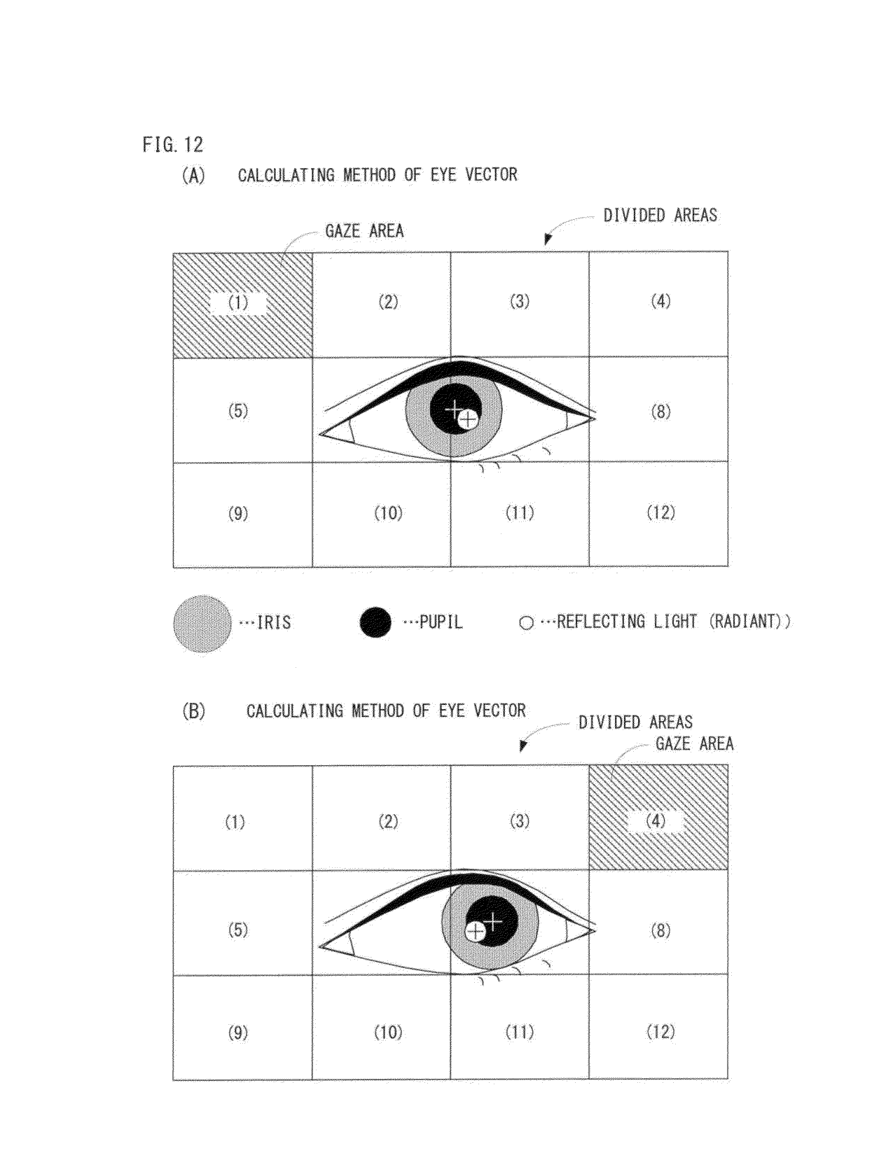

For example, when a calibration is started, first, a divided area (1) is set as a gaze area as shown in FIG. 12(A) wherein an image of a left eye of the user as imaged in a case that the divided area (1) is set as a gaze area is shown. Based on the imaged image, an eye vector in this case is detected and a detected eye vector is stored as a reference vector N (here, N=1) with respect to the divided area (1). Likewise, up to the divided area (20), the gaze area is set sequentially, and an eye vector of each case is detected, and a detected eye vector is stored as a reference vector N with respect to the concerned divided area. Furthermore, in FIG. 12(B), an image of a left eye of the user imaged in a case that the divided area (4) is set as a gaze area is shown.

In addition, in FIG. 12(A) and FIG. 12(B), divided areas (13)-(20) of two bottom rows are omitted.

In the calibration, a line of sight of the user is guided in an order shown by the identification information (numbers) of the divided areas (1)-(20), and for example, a divided area to be gazed is indicated by a predetermined color.

Then, when the eye-controlled operation is actually performed, an eye vector detected based on an imaged image (for the sake of convenience of description, called as “current vector”) W is compared with respective one of the reference vectors N and a divided area stored in correspondence to the most approximate reference vector N is determined as an area that the user gazes at (a gaze area).

In addition, since a distance between the mobile phone 10 (infrared camera 30) and a face of the user (eye) is different in most cases at a time of the calibration and at a time that the eye-controlled operation is actually performed, the current vector W is scaled (enlarged or reduced).

In this embodiment shown, the current vector W is scaled based on a distance L0 between the left and right eyes at a time that the reference vector N is detected and a distance L1 between the left and right eyes at a time that the current vector W is detected. In addition, a distance L between both eyes is determined by a distance (horizontal distance) between a center position of the reflecting light of the infrared light on the left eye and a center position of the reflecting light of the infrared light on the right eye as shown in FIG. 10(B).

As shown in FIG. 10(B), an imaged image is a minor image of a face of the user, and accordingly, in this Figure, an image at a left side is an image of the left eye of the user and an image at a right side is an image of the right eye of the user.

Specifically, the current vector W is scaled according to the following equation (1) where an X axis component of the current vector W is Wx and the Y axis component is Wy, and an X axis component of the current vector W after scaled is Wx1 and the Y axis component is Wy1.

(Wx1,Wy1)=(Wx*L1/L0,Wy*L1/L0) (1)

A length r_{N} of a differential vector between respective one of the reference vectors N and the current vector W after scaled is respectively calculated in accordance with the following equation (2). Then, in a case that the length of the differential vector is shortest, it is determined that the current vector W after scaled and the reference vector N are most closely related to each other. Based on a determination result, a divided area being in correspondence to a reference vector N in a case that the length of the differential vector is shortest is determined as a current gaze area. Here, the reference vector N (N=1, 2, - - -, 20) is indicated by (Xv_{N}, Yv_{N}).

r_{N}=√{(Xv_{N}−Wx1)²+(Yv_{N}−Wy1)²} (2)

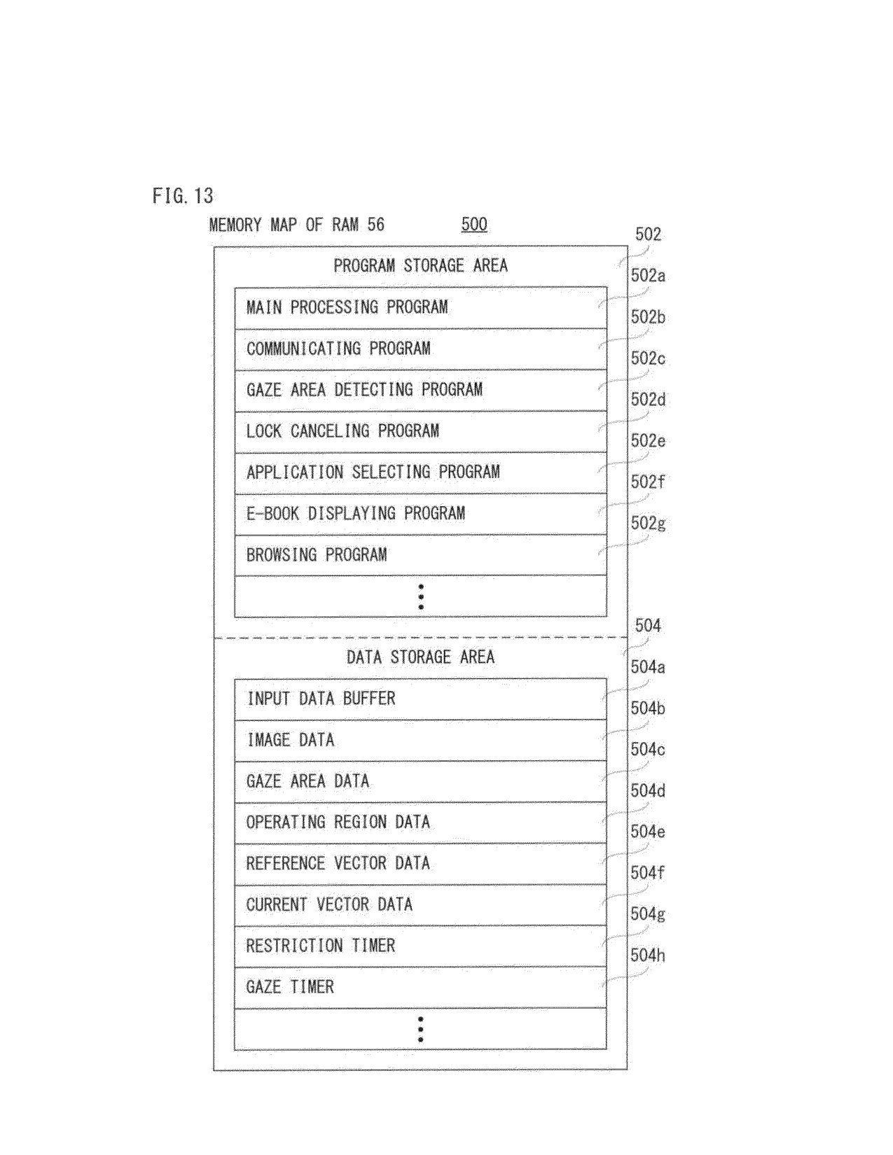

FIG. 13 is a view showing one example of a memory map 500 of the RAM 56 shown in FIG. 2. As shown in FIG. 13, the RAM 56 includes a program storage area 502 and a data storage area 504. The program storage area 502 stores programs such as a main processing program 502a, a communication program 502b, a gaze area detecting program 502c, a lock canceling program 502d, an application selecting program 502e, an e-book displaying program 502f, a browsing program 502g, etc.

The main processing program 502a is a program for processing a main routine of the mobile phone 10. The communicating program 502b is a program for performing telephone conversation processing with other telephones or for communicating with other telephones or computers via a communication network (a telephone network, internet). The gaze area detecting program 502c is a program for detecting a divided area on a displaying surface of the display 14, which is gazed at by a user of the mobile phone 10 as a gaze area.

The lock canceling program 502d is a program for canceling a lock state in accordance with an operation of the user in a case that the lock function is turned-on. In this embodiment shown, a case that the lock is canceled by the eye-controlled operation is described, but it is needless to say that the lock can also be canceled by a key operation or a touch operation. Likewise, in the application selecting program 502e, the e-book displaying program 502f and the browsing program 502g, not only the eye-controlled operation but also the key operation or the touch operation can be used.

The application selecting program 502e is a program for selecting (executing) an application or function installed in the mobile phone 10. The e-book displaying program 502f is a program for executing a processing related to an operation for an e-book (turning over of pages and so on). The browsing program 502g is a program for performing processing related to an operation for a browser (a displaying of a page of an internet site, a scrolling of a screen, a page movement and so on).

Although not shown, the program storage area 502 is further stored with an image producing processing program, an image displaying program, a sound outputting program, and a program for other application or function such as a memo pad, an address book, etc.

The data storage area 504 is provided with an input data buffer 504a. Furthermore, the data storage area 504 is stored with image data 504b, gaze area data 504c, operating region data 504d, reference vector data 504e and current vector data 504f. The data storage area 504 is further provided with a restriction timer 504g and a gaze timer 504h.

The input data buffer 504a is an area for temporarily storing key data and touch coordinates data according to a time series. The key data and the touch coordinates data are erased after use for processing by the processor 40.

The image data 504b is data for displaying various kinds of screens (100, 150, 200, 250, 300, 350, 400 and so on). The gaze area data 504c is data for identifying a divided area that the user currently gazes at, i.e., a gaze area.

The operating region data 504d is data of positions (coordinates) for defining operating regions for a current displayed screen and data indicative of a content for an operation (action) or function (application) being set in correspondence to the operating regions.

The reference vector data 504e is data for the eye vectors each corresponding to each of the divided areas, acquired by the calibration, i.e., the reference vectors N. The current vector data 504f is data for the eye vector currently detected, i.e., the aforementioned current vector W.

The restriction timer 504g is a timer for counting a restricted time during when the eye-controlled operation is performed for lock canceling. The gaze time 504h is a timer for counting a time that the user gazes at the same divided area.

Although not shown, the data storage area 504 is further stored with other data and provided with other timers (counters), and provided with flags, which are all necessary for executing respective programs stored in the program storage area 502.

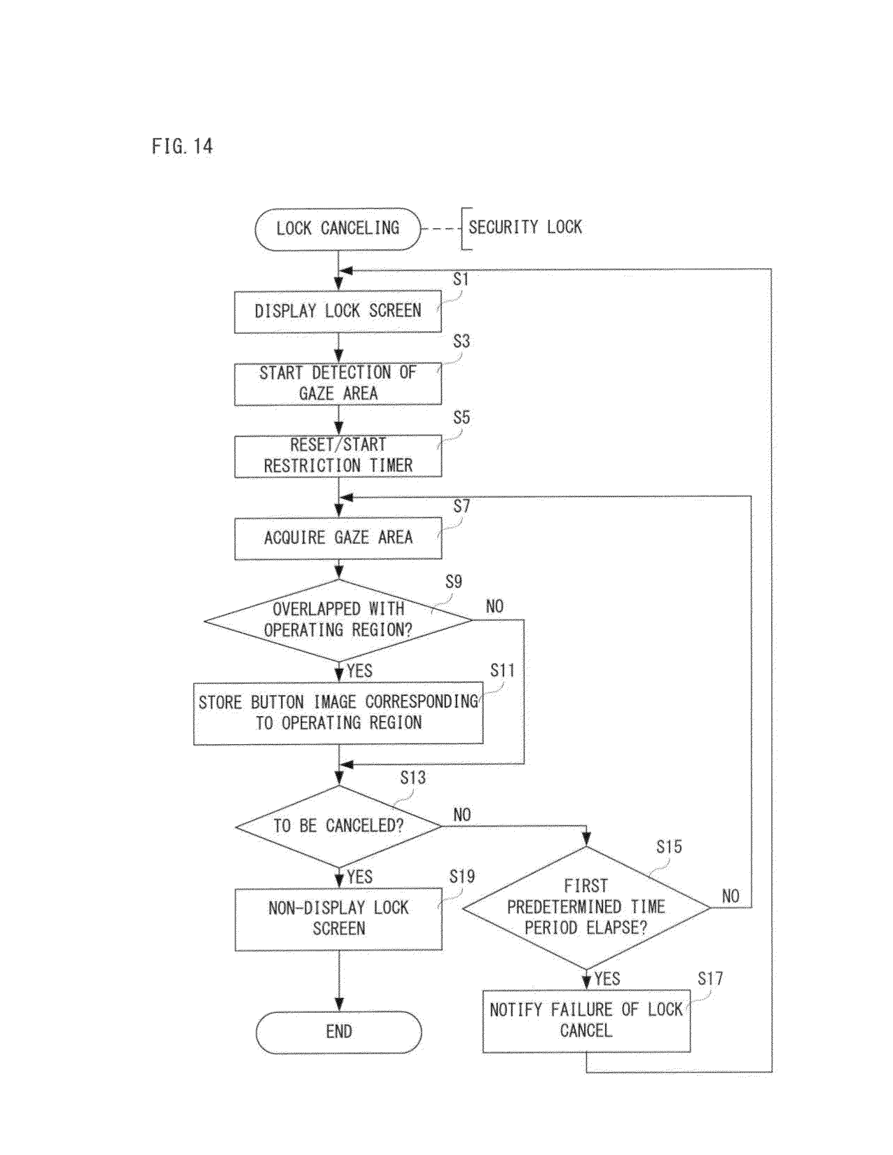

FIG. 14 is a flowchart showing a lock canceling process (security lock) by the processor 40 shown in FIG. 2. As shown in FIG. 14, if the lock canceling process is started, the processor 40 displays a lock screen 100 as shown in FIG. 3(A) or FIG. 3(B) on the display 14 in a step S1. At this time, operating regions in correspondence to the displaying regions of respective button images 110 or button images 120 are set, and corresponding operating region data 504d is stored in the data storage area 504. In the following, such a setting of the operating regions according to a screen is also employed for a case that respective screens are displayed. Furthermore, as described above, the lock canceling process is performed at a time that the use of the mobile phone 10 is to be started (that is, at a time that a power for the display 14 is turned-on, or at a time that the mobile phone 10 is activated by turning-on a main power) in a case that the security lock function is turned-on, or at a time that a predetermined application or function is to be executed (started).

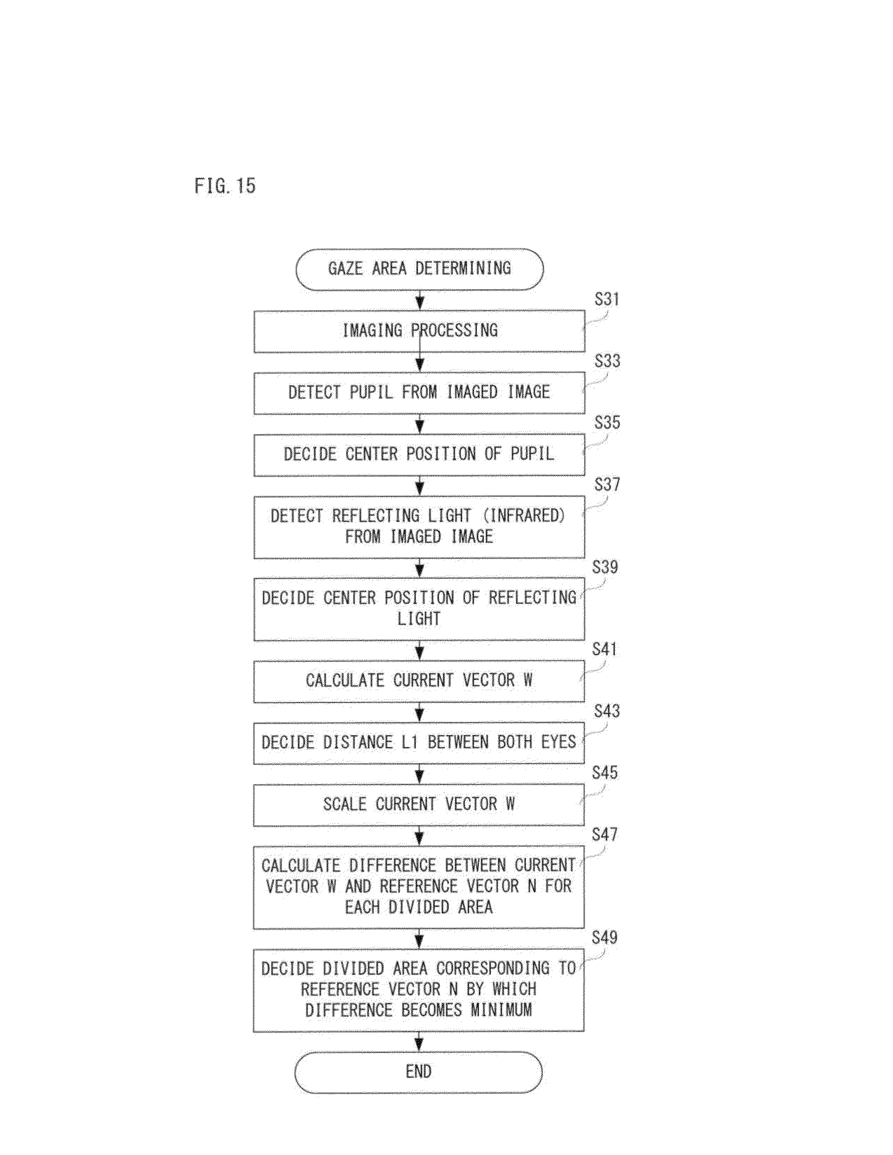

In a next step S3, a detection of a gaze area is started. That is, the processor 40 executes the gaze area detecting process (FIG. 15) described later in parallel with the lock canceling process. In a step S5, the restriction timer 504g is reset and started.

In a succeeding step S7, the processor 40 acquires a gaze area detected by the gaze area detecting process with reference to the gaze area data 504c. In a next step S9, it is determined whether or not the acquired gaze area overlaps with the operating region. Here, the operating region data 504d is referred and it is determined whether or not the gaze area previously acquired overlaps with the operating region. If “NO” is determined in the step S9, that is, if the gaze area acquired does not overlap with the operating region, the process proceeds to a step S13. On the other hand, if “YES” is determined in the step S9, that is, if the acquired gaze area overlaps with the operating region, in a step S11, the button image corresponding to the operating region is stored, and then, the process proceeds to the step S13. That is, an input secret code number and so on are stored.

In the step S13, it is determined whether or not the security lock is to be canceled. That is, it is determined whether or not the input secret code number or operation procedure is correct. In addition, a secret code number or operation procedure set in advance is stored in the flash memory 54, and at that time, the same is referred. If “NO” is determined in the step S13, that is, if the lock is not to be canceled, in a step S15, it is determined whether or not a count value of the restriction timer 504g reaches or exceeds the first predetermined time period (10 seconds, for example). If “NO” is determined in the step S15, that is, if the first predetermined time period does not elapse, the process returns to the step S7. If “YES” is determined in the step S15, that is, if the first predetermined time period elapses, in a step S17, a failure of lock canceling is notified, and then, the process returns to the step S1. Specifically, in the step S17, the processor 40 displays a message that the lock canceling fails on the display 14, or outputs from a speaker (speaker 18 or other speakers) a sound (music, melody) that the lock cancel fails, or performs both of them.

If “YES” is determined in the step S13, that is, if the lock is to be canceled, in a step S19, the lock screen 100 is put out (non-displayed) and the lock canceling process is terminated.

FIG. 15 is a flowchart showing a gaze area detecting process by the processor 40. As shown in FIG. 15, when the gaze area detecting process is started, the processor 40 performs imaging processing in a step S31. Here, the infrared camera 30 performs imaging processing in accordance with the imaging instructions by the processor 40. Then, image processing is applied to the imaged image data output by the infrared camera 30 in the imaged image processing circuit 62, and the imaged image data of the monochrome is input to the processor 40.

In a next step S33, the pupil is detected in the imaged image, and in a step S35, a center position of the pupil is determined. In a step S37, a reflecting light of the infrared ray (infrared light) in the imaged image is detected, and in a step S39, a center position of the reflecting light is determined. Then, in a step S41, a current vector W having a start point at the center position of the reflecting light and an end point at a center position of the pupil is calculated.

Subsequently, a distance L between both eyes is determined in a step S43. Here, a distance L1 between the center position of the reflecting light of the infrared light on the left eye and the center position of the reflecting light of the infrared light on the right eye is evaluated. In a next step S45, the current vector W is scaled (enlarged or reduced) in accordance with the aforementioned equation (1). Furthermore, in a step S47, a differential vector between the current vector W after scaled and the reference vector N for each divided area is calculated in accordance with the equation (2). Then, in a step S49, a divided area corresponding to the reference vector N that the length of the reference vector becomes minimum (shortest) is determined as a gaze area, and the gaze area detecting process is terminated. The identification information of the gaze area (divided area) determined in the step S49 is stored (renewed) as the gaze area data 504c.

In addition, if once the gaze area detecting process is started, until performing processing of a predetermined function is ended, the gaze area detecting process is repeatedly executed; however, the gaze area detecting process may be terminated by performing a predetermined key operation or touch operation. This is true in a case that the gaze area detecting process is to be executed.

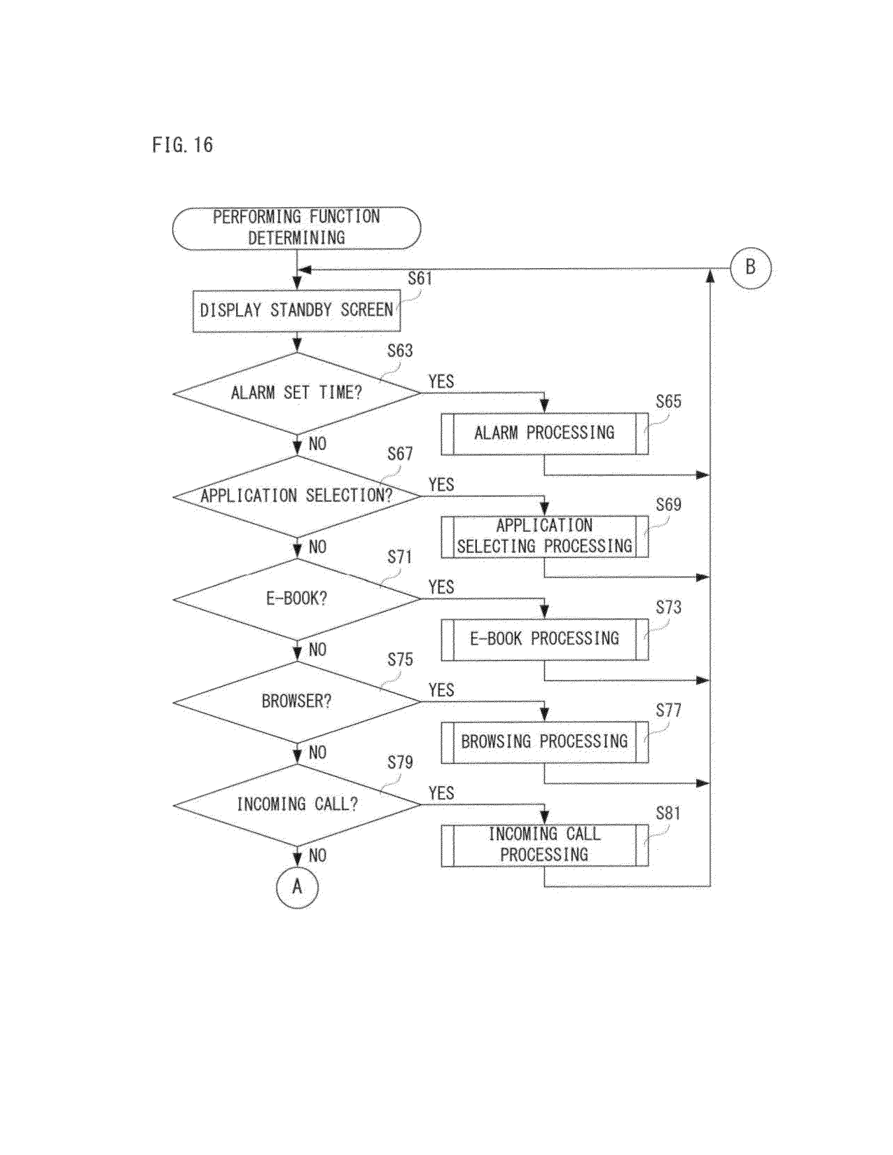

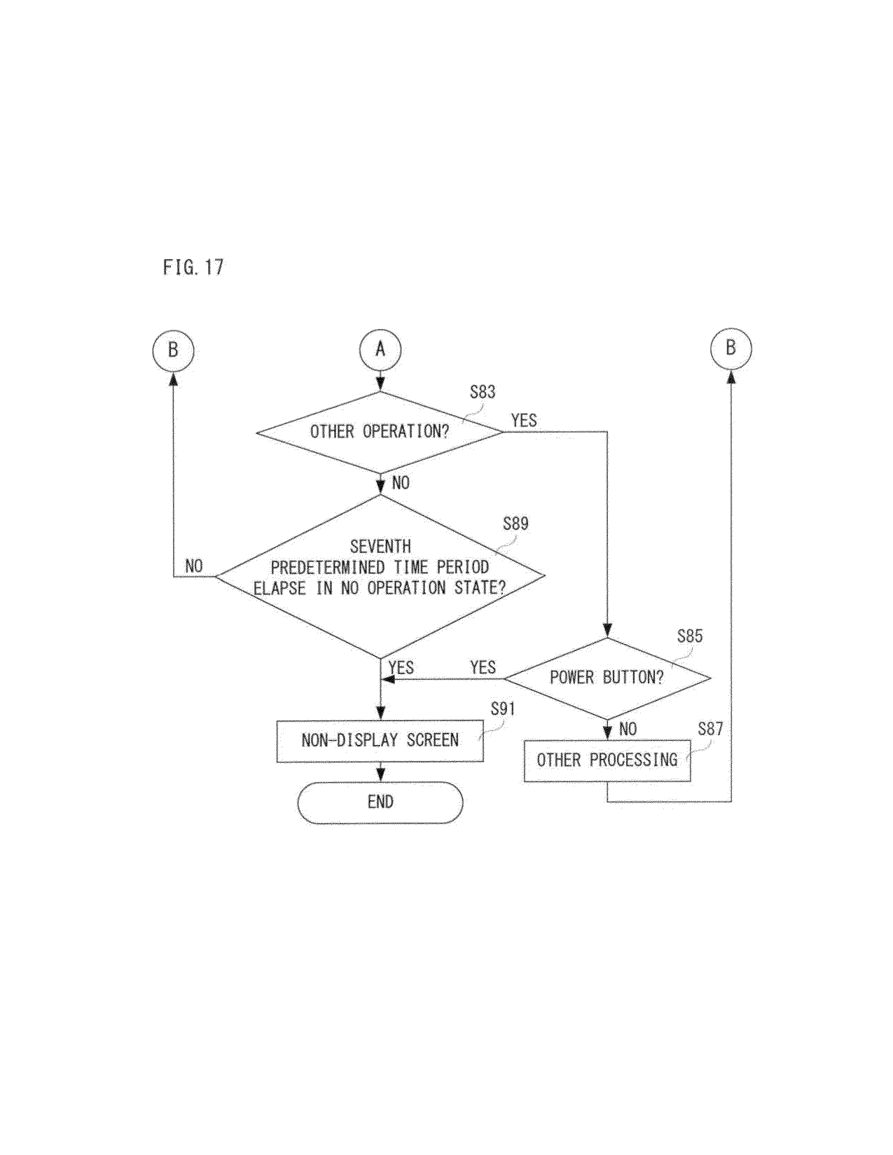

FIG. 16 and FIG. 17 shows a flowchart of a performing function determining process by the processor 40 shown in FIG. 2. When the performing function determining process is started, in a step S61, the processor 40 displays a standby screen. The standby screen may be the above-described time displaying screen 300 or the like, for example, and settable by the user.

If the lock function is set, the above-described lock canceling process is executed, and after the lock is canceled, the performing function determining process is started. If the lock function is not set, the above-described lock canceling process is not performed, and the performing function determining process is started when the user starts the use of the mobile phone 10.

In a next step S63, the processor 40 determines whether or not a current time is an alarm set time (an alarm time). That is, the processor 40 determines, by referring to a current time measured by the RTC 40a, whether or not the current time reaches the alarm time. In a case that the alarm is not set, the processor 40 determines that the current time is not the alarm time.

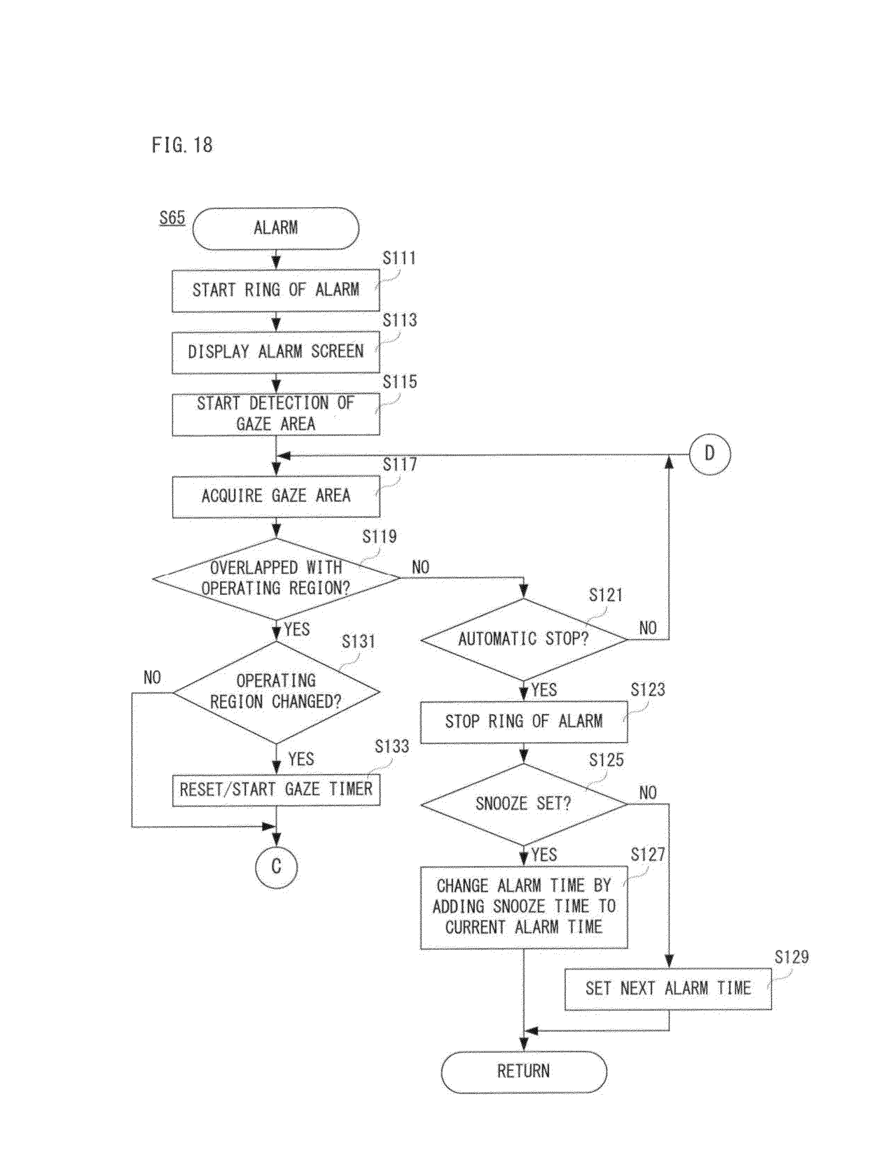

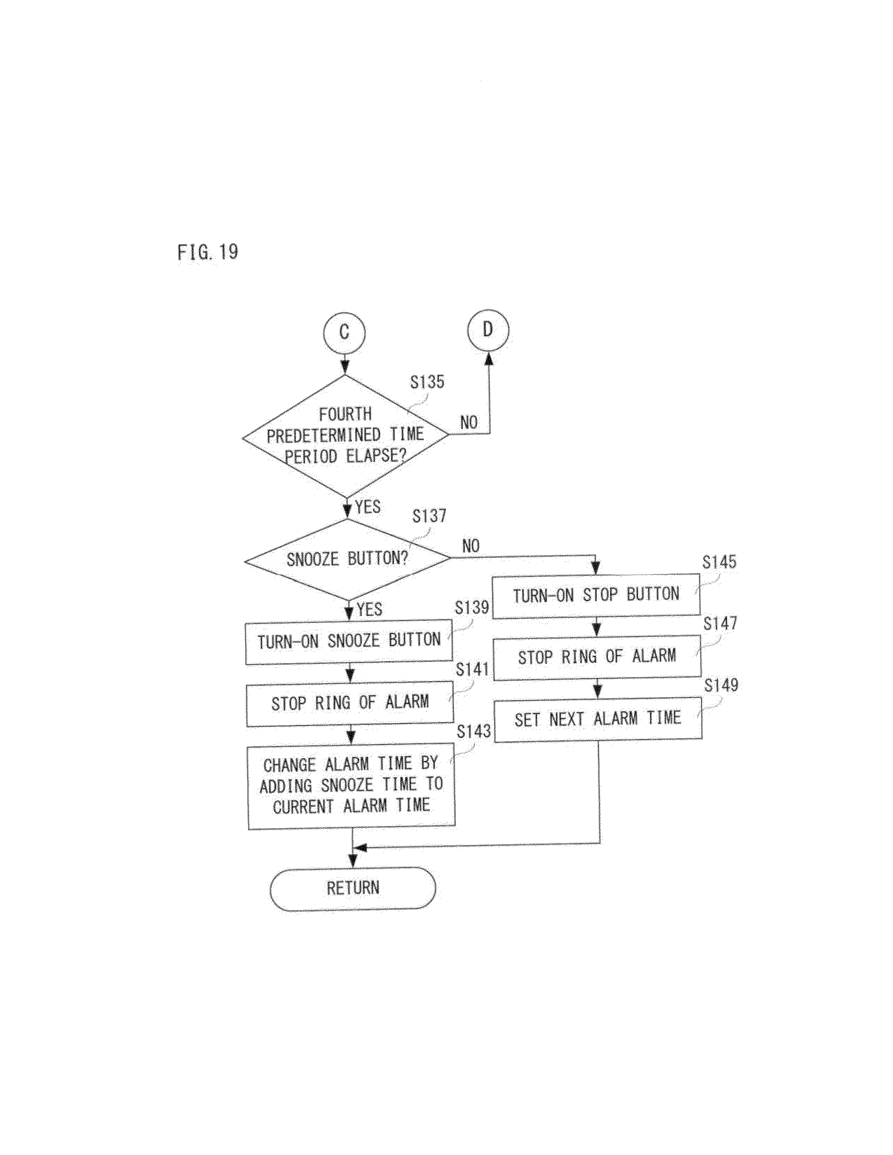

If “YES” is determined in the step S63, that is, if the current time is the alarm time, in a step S65, an alarming process (see FIG. 18 and FIG. 19) described later is performed, and then, the process returns to the step S61. If “NO” is determined in the step S63, that is, if the current time is not the alarm time, in a step S67, it is determined whether or not an input for performing an application selection exists. Here, the processor 40 determines whether or not a designation for displaying the application selecting screen 150 is input.

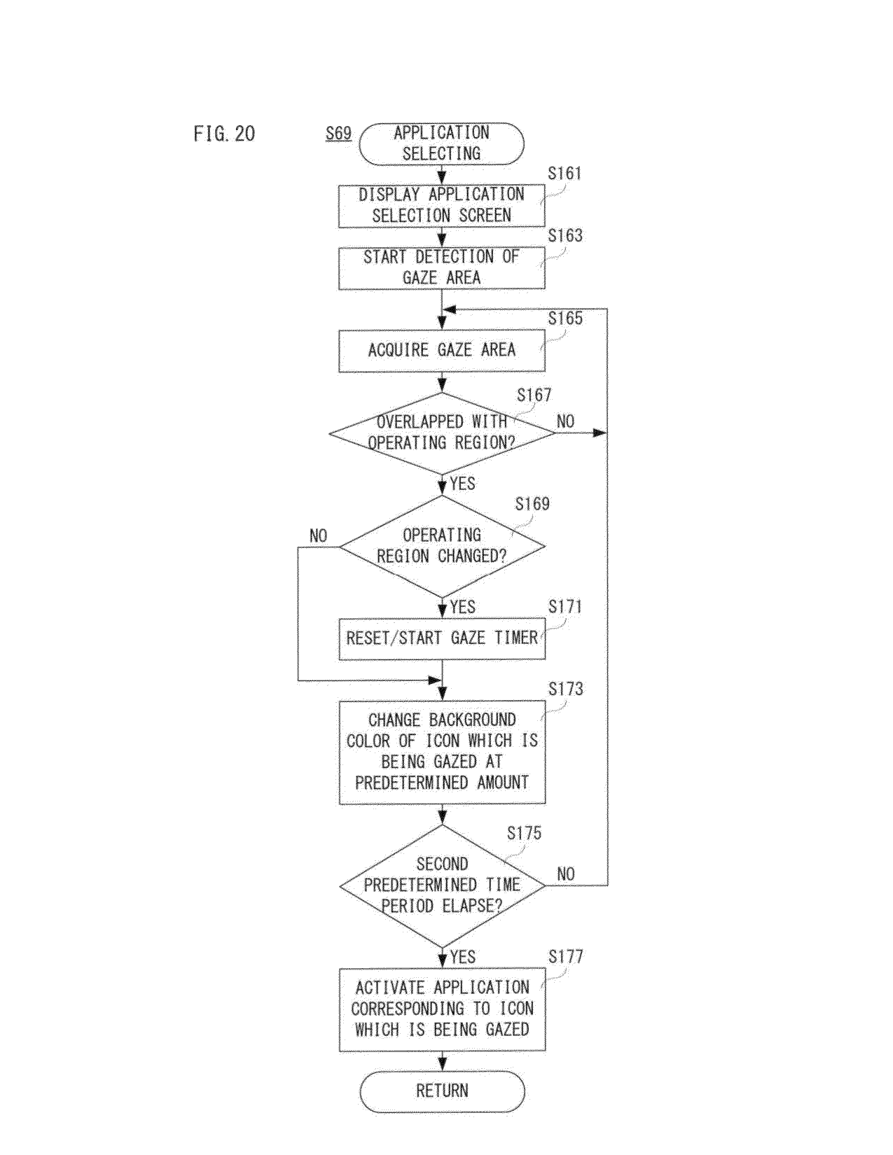

If “YES” is determined in the step S67, that is, if an input for performing the application selection exists, in a step S69, an application selecting process (see FIG. 20) described later is executed, and then, the process returns to the step S61. If “NO” is determined in the step S67, that is, if the input for performing the application selecting does not exist, in a step S71, it is determined whether or not e-book processing is to be performed. In addition, an instruction for performing an e-book is performed by operating the concerned icon 160 in the application selecting process. This is true for an instruction for executing browsing processing described later.

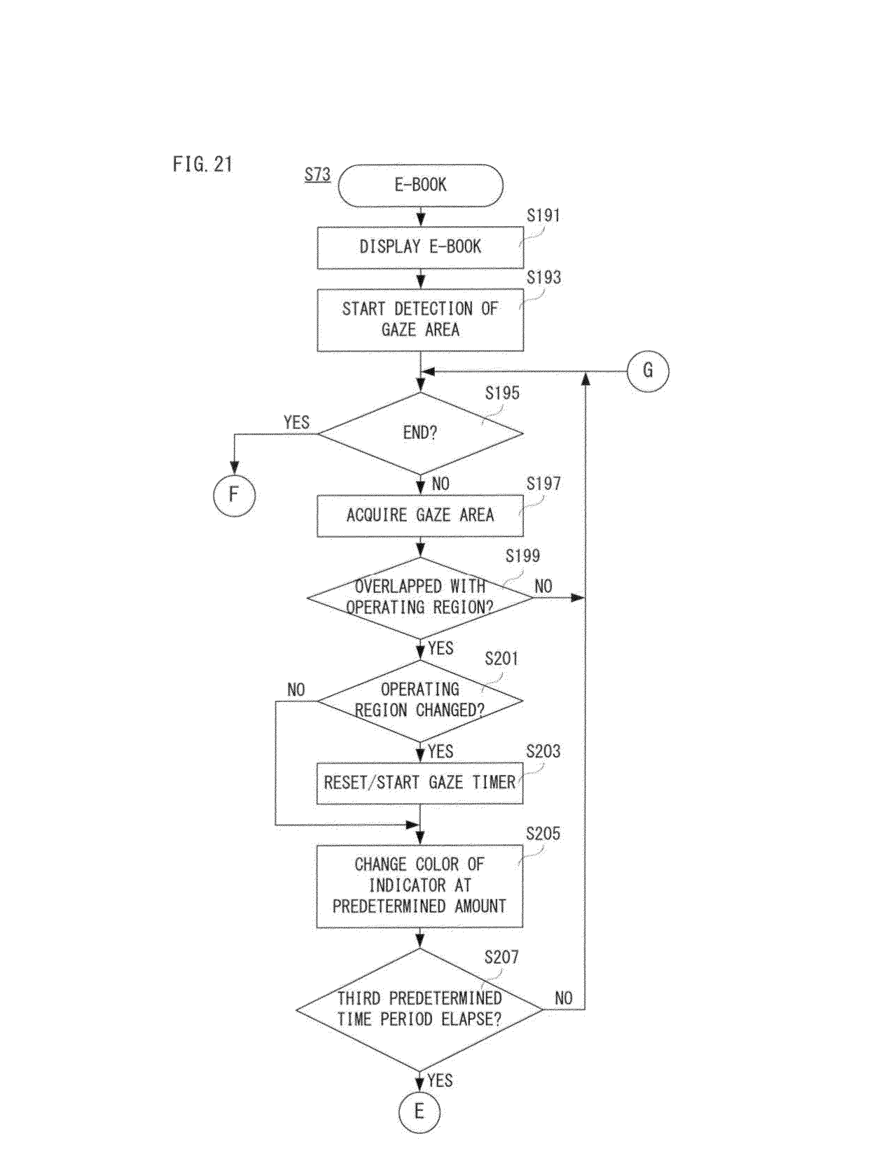

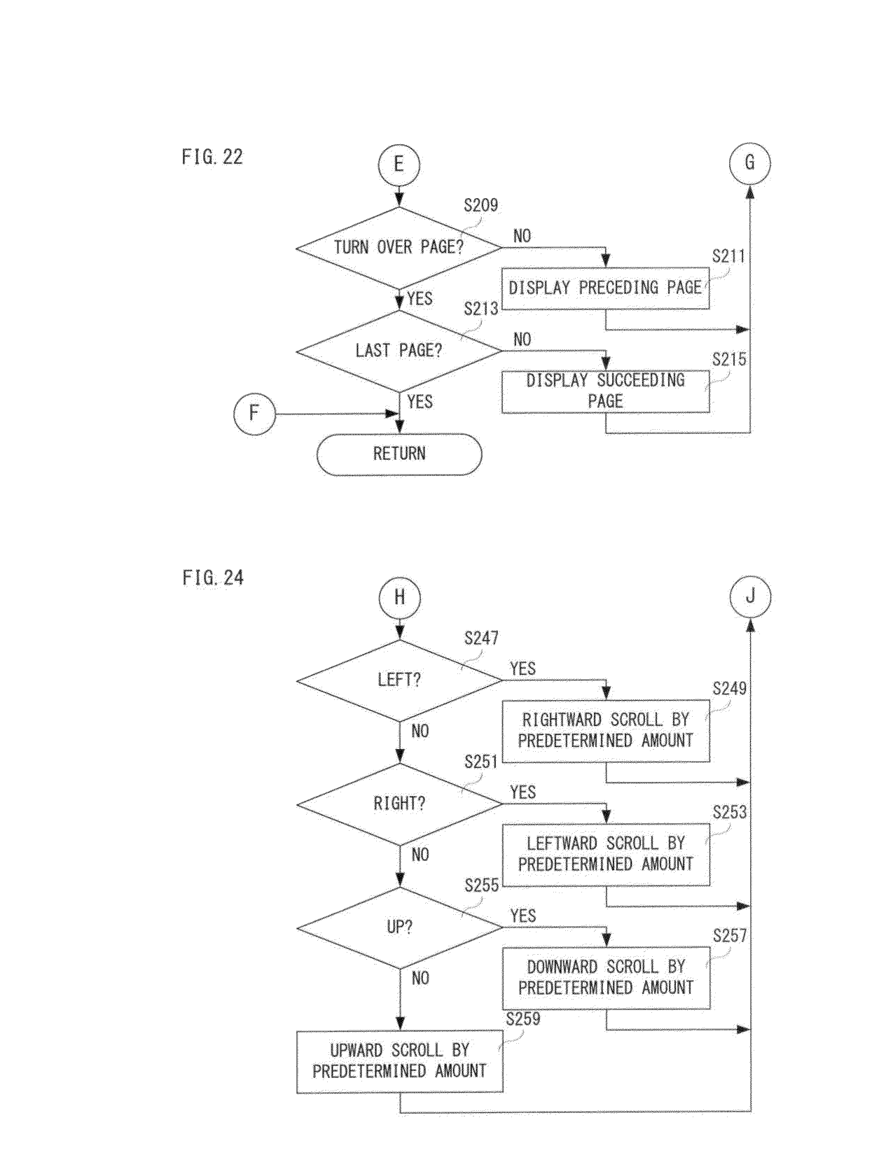

If “YES” is determined in the step S71, that is, if the e-book processing is to be executed, in a step S73, the e-book processing (see FIG. 21 and FIG. 22) described later is performed, and the process returns to the step S61. If “NO” is determined in the step S71, that is, if the e-book processing is not to be executed, in a step S75, it is determined whether or not the browsing processing is to be executed.

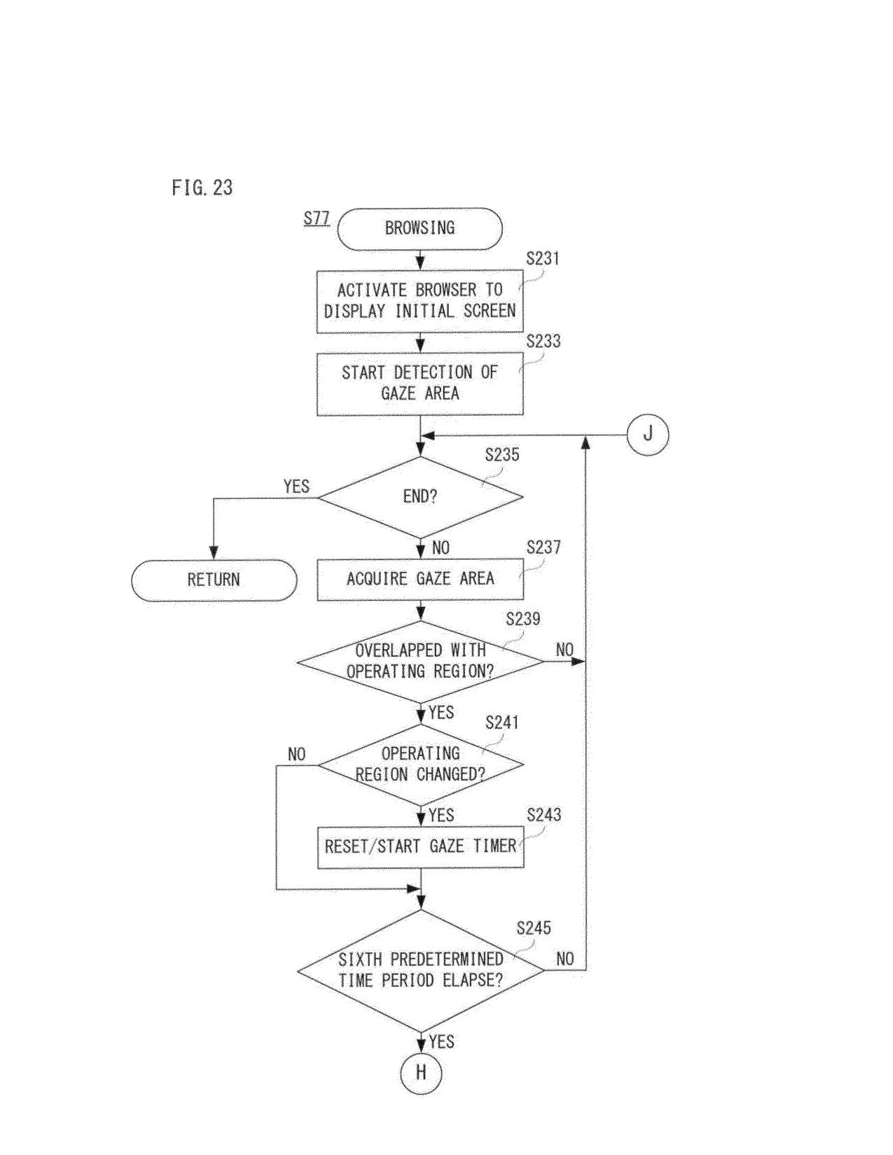

If “YES” is determined in the step S75, that is, if the browser is to be executed, in a step S77, the browsing processing (see FIG. 23 and FIG. 24) described later is performed, and the process returns to the step S61. If “NO” is determined in the step S75, that is, if the browsing processing is not to be executed, in a step S79, it is determined whether or not an incoming call exists.

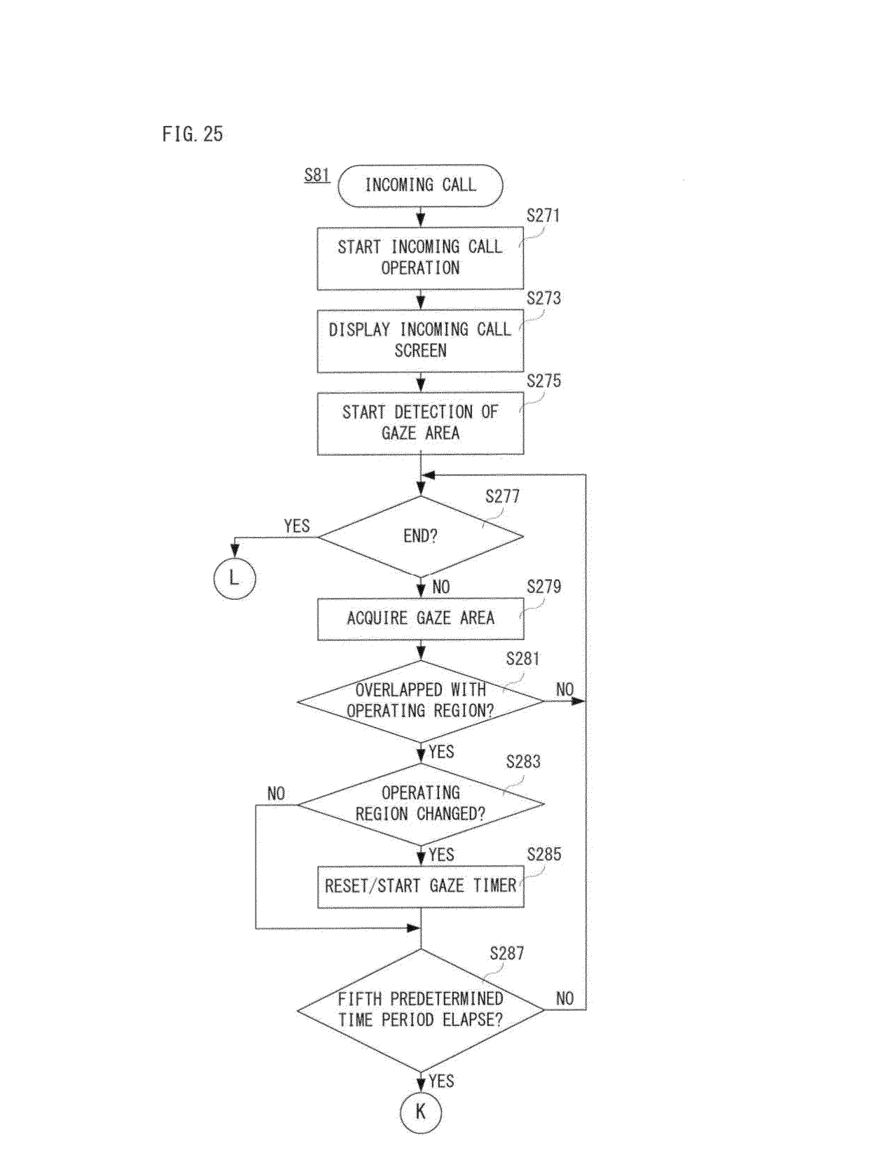

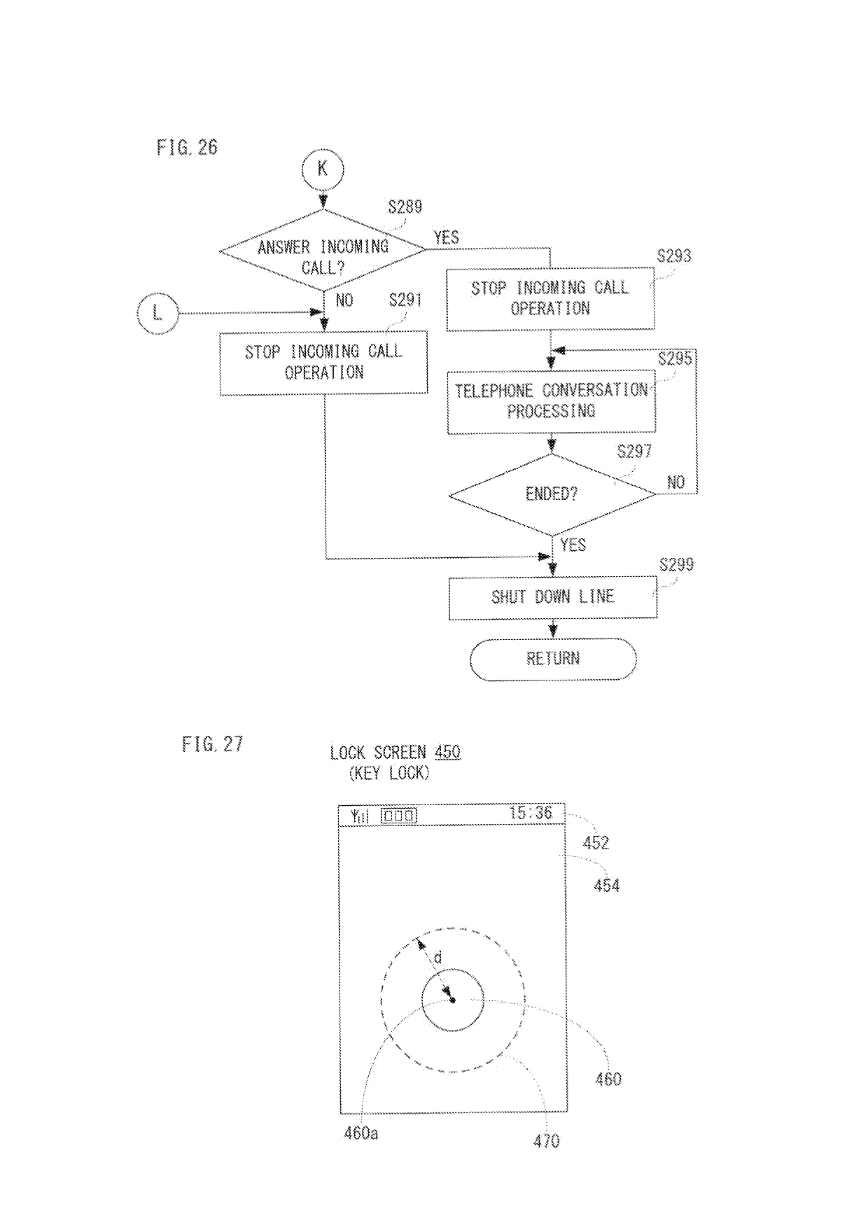

If “YES” is determined in the step S79, that is, if an incoming call exists, in a step S81, incoming call processing (see FIG. 25 and FIG. 26) described later is executed, and then, the process returns to the step S61. If “NO” is determined in the step S79, that is, if an incoming call does not exist, it is determined whether or not another operation exists in a step S83 shown in FIG. 17. Here, the processor 40 determines whether or not a further application or function other than the e-book and the browser is selected, or whether or not an operation for telephone calling is performed, or whether or not a power button is turned-on, based on a key operation or a touch operation.

If “YES” is determined in the step S83, that is, if a further operation exists, it is determined whether or not an operation of the power button is performed in a step S85. If “YES” is determined in the step S85, that is, if the operation for the power button is performed, the process proceeds to the step S91. If “NO” is determined in the step S85, that is, if not an operation for the power button, in a step S87, the further processing is performed, and then, the process returns to the step S61 shown in FIG. 16. In addition, the further processing may be processing for an application or function other than the e-book and the browser or processing for telephone calling as described above.

If “NO” is determined in the step S83, that is, if no further operation exists, in a step S89, it is determined whether or not a seventh predetermined time period (10 seconds, for example) elapses in a no operation state. For example, a time that a key operation and a touch operation do not exist is counted by a timer (no operation timer) different from the restriction timer 504g and the gaze timer 504h. Such a no operation timer is reset and started when the key operation or the touch operation is ended. For example, the seventh predetermined time period is settable between 5 seconds and 30 seconds.

If “NO” is determined in the step S89, that is, if the seventh predetermined time period does not elapse in the no operation state, the process returns to the step S61. If “YES” is determined in the step S89, that is, if the seventh predetermined time period elapses in the no operation state, in a step S91, the screen is put out (the display 14 is turned-off), and the performing function determining process is terminated.

FIG. 18 and FIG. 19 show a flowchart of alarm processing in the step S65 shown in FIG. 16. As shown in FIG. 18, when the alarm processing is started, the processor 40 starts a ring of alarm in a step S111. The processor 40 outputs an alarm sound, for example; however, if a vibration motor is provided, the mobile phone 10 itself may be vibrated by driving the vibration motor. In addition, both of the output of the alarm sound and the drive of the vibration motor may be performed.

In a step S113, an alarm screen 250 as shown in FIG. 6 is displayed on the display 14. Subsequently, in a step S115, a detection of a gaze area is started. That is, the gaze area detecting process shown in FIG. 15 is executed in parallel with the alarm processing shown in FIG. 18 and FIG. 19. Then, in a step S117, the gaze area is acquired.

Next, in a step S119, it is determined whether or not the gaze area is overlapped with the operating region (here, a displaying area of the button image 260 or 262) set in the alarm screen 250. If “NO” is determined in the step S119, that is, if the gaze area does not overlap with the operating region, in a step S121, it is determined whether or not the alarm is to be automatically stopped. It is determined whether or not a time (30 seconds-5 minutes, for example) from the ring of alarm started to the automatic stopping elapses. A timer for such determination may be provided, or it is determined whether or not the automatic stopping is to be performed with referring to a time counted by the RTC 40a.

If “NO” is determined in the step S121, that is, in a case that the alarm is not to be automatically stopped, the process returns to the step S117. If “YES” is determined in the step S121, that is, if the alarm is to be automatically stopped, in a step S123, the ring of alarm is stopped, and in a step S125, it is determined whether or not a setting of a snooze is present.

If “YES” is determined in the step S125, that is, if the setting of a snooze exists, in a step S127, an alarm time is changed by adding the current alarm time to a time of the snooze, and then, the process returns to the performing function determining process. If “NO” is determined in the step S125, that is, if no setting of the snooze is present, in a step S129, a next alarm time is set, and then, the process returns to the performing function determining process. In addition, if a next alarm is not set, the processor 40 does not perform processing in the step S129, and returns to the performing function determining process. This is true for a step S149 described later.

If “YES” is determined in the step S119, that is, if the gaze area overlaps with the operating region, in a step S131, it is determined whether or not the operating region with which the gaze area overlaps is changed. That is, the processor 40 determines whether or not the operating region with which the gaze area overlaps differs from at the preceding time to at the current time. If “NO” is determined in the step S131, that is, if the operating region is not changed, the process proceeds to a step S135 shown in FIG. 19. On the other hand, if “YES” is determined in the step S131, that is, if the operating region is changed, the process proceeds to the step S135 after the gaze timer 504h is reset and started in a step S133. In addition, at the beginning of the detection of the gaze area, it is determined that the operating region is changed in the step S131 if and when the gaze area overlaps with the operating region.

As shown in FIG. 19, in the step S135, it is determined whether or not a fourth predetermined time period (1-3 seconds, for example) elapses. That is, the processor 40 determines whether or not a time that the user watches the button image 260 or the button image 262 reaches the fourth predetermined time period by referring to a count value of the gaze timer 504h.

If “NO” is determined in the step S135, that is, if the fourth predetermined time period does not elapse, the process returns to the step S117 shown in FIG. 18. If “YES” is determined in the step S135, that is, if the fourth predetermined time period elapses, in a step S137, it is determined whether or not the gaze area is a snooze button. That is, it is determined whether or not the user watches the button image 260.

If “YES” is determined in the step S137, that is, if the gaze area is the snooze button, the snooze button, i.e., the button image 260 is turned-on in a step S139, and the ring of alarm is stopped in a step S141, and then, an alarm time is changed by adding the snooze time to the alarm time in a step S143, and the process returns to the performing function determining process.

If “NO” is determined in the step S137, that is, if the gaze area is a stop button, in a step S145, the stop button, i.e., the button image 262 is turned-on, and the ring of alarm is stopped in a step S147, and a next alarm time is set in a step S149, and then, the process returns to the performing function determining process.

FIG. 20 is a flowchart showing application selecting processing of the step S69 shown in FIG. 16. In the following, this application selecting processing will be described, but processing or steps the same or similar to those of the above-described alarm processing are simply described. This is true for the e-book processing, the browsing processing and the incoming call processing each described later.

When the application selecting processing is started, the processor 40 displays an application selecting screen 150 as shown in FIG. 4 on the display 14 in a step S161, as shown in FIG. 20. In a next step S163, a detection of a gaze area is started, and the gaze area is acquired in a step S165. Then, in a step S167, it is determined whether or not the gaze area overlaps with the operating region.

If “NO” is determined in the step S167, the process returns to the step S165. If “YES” is determined in the step S167, it is determined whether or not the operating region with which the gaze area overlaps is changed in a step S169. If “NO” is determined in the step S169, the process proceeds to a step S173. If “YES” is determined in the step S169, in a step S171, the gaze timer 504h is reset and started, and then, the process proceeds to the step S173.

In the step S173, a background color of an icon 160 being gazed at is changed at a predetermined amount. In a next step S175, it is determined whether or not a second predetermined time period (1-3 seconds, for example) elapses. That is, the processor 40 determines whether or not a time that the user watches the same icon 160 reaches the second predetermined time period with referring to a count value of the gaze timer 504h.

If “NO” is determined in the step S175, that is, if the second predetermined time period does not elapse, the process returns to the step S165. If “YES” is determined in the step S175, that is, if the second predetermined time period elapses, in a step S177, an application or function corresponding to the gazed icon 160 is activated, and then, the process returns to the performing function determining process.

In addition, if the activated application or function is an e-book or a browser, as described later, the e-book processing and the browsing processing are executed. Furthermore, as described above, when the second predetermined time period elapses, the background color of the gazed icon 160 is entirely changed.

FIG. 21 and FIG. 22 show a flowchart of the e-book processing of the step S73 shown in FIG. 16. When the e-book processing is started, as shown in FIG. 21, the processor 40 displays an e-book in a step S191. Here, as shown in FIG. 5(A), an e-book displaying screen 200 in which a first page or a page that a book marker is placed of a designated e-book is displayed. In addition, at the beginning of the e-book displaying screen 200 being displayed, the indicator 206 is blank.

In a next step S193, a detection of a gaze area is started. It is determined whether or not the e-book processing is to be terminated in a next step S195. That is, the processor 40 determines whether or not a termination of the e-book processing is instructed by the user. If “YES” is determined in the step S195, that is, if the e-book processing is to be terminated, as shown in FIG. 22, the process returns to the performing function determination process.

If “NO” is determined in the step S195, that is, if the e-book processing is not to be terminated, in a step S197, a gaze area is acquired. In a succeeding step S199, it is determined whether or not the gaze area overlaps with the operating region (210 or 212). If “NO” is determined in the step S199, the process returns to the step S195, but if “YES” is determined in the step S199, if it is determined whether or not the operating region with which the gaze area overlaps is changed in a step S201.

If “NO” is determined in the step S201, the process proceeds to a step S205. On the other hand, if “YES” is determined in the step S201, the gaze timer 504h is reset and started in a step S203, and then, the process proceeds to the step S205 wherein a color of the indicator 206 is changed at a predetermined amount. That is, a blank of the indicator 206 is filled with a predetermined color at a predetermined amount.

In a step S207, it is determined whether or not a third predetermined time period (1-3 seconds, for example) elapses. That is, the processor 40 determines whether or not a time that the user watches the predetermined region (210 or 212) reaches the third predetermined time period with referring to a count value of the gaze timer 504h. If “NO” is determined in the step S207, that is, if the third predetermined time period does not elapse, the process returns to the step S195. If “YES” is determined in the step S207, that is, if the third predetermined time period elapses, it is determined whether or not the eye-controlled operation is the page advancing in a step S209 shown in FIG. 22. Here, the processor 40 determines whether or not the user gazes at the operating region 210.

If “NO” is determined in the step S209, that is, in a case that the user gazes at the operating region 212, it is determined that the eye-controlled operation is the page returning, and thus, a preceding page is displayed in a step S211, and then, the process returns to the step S195 shown in FIG. 21. If “YES” is determined in the step S209, that is, if the user gazes at the operating region 210, it is determined that the eye-controlled operation is the page advancing, and in a step S213, it is determined whether or not the current page is the last page.

If “NO” is determined in the step S213, that is, if the current page is not the last page, in a step S215, a succeeding page is displayed, and then, the process returns to the step S195. If “YES” is determined in the step S213, that is, if the current page is the last page, the e-book processing is terminated, and then, the process returns to the performing function determination process.

FIG. 23 and FIG. 24 show a flowchart of a browsing processing in the step S77 shown in FIG. 16. In the following, the browsing processing is described, but the same or similar process as those of the above-described application selecting process or the e-book processing are simply described.

As shown in FIG. 23, when the browsing processing is started, the processor 40 activates a browser and displays an initial screen in a step S231. For example, the processor 40 displays a screen of an internet site that is set as a homepage. In addition, by inputting a desired address (URL) through a key operation or a touch operation, it is possible to display a screen of a desired internet site other than the homepage. Therefore, there is an occasion that a map displaying screen 400 as shown in FIG. 8 is displayed. Furthermore, here, a case that the screen is scrolled by an eye-controlled operation is described, but, by turning-on (click) a button image or a hyper link by an eye-controlled operation, a screen of an internet site that the button image or the hyper link is set can be displayed.

In a next step S233, the processor 40 starts a detection of a gaze area, and in a step S235, it is determined whether or not the browser is to be terminated. Here, the processor 40 performs such a determination based on whether or not a termination of the browsing processing is instructed by the user. If “YES” is determined in the step S235, that is, if the browser is to be terminated, the process returns to the performing function determination process. If “NO” is determined in the step S235, that is, if the browsing processing is not to be terminated, a gaze area is acquired in a step S237.

In a next step S239, it is determined whether or not the gaze area overlaps with the operating region (410L, 410R, 410T, 410B). If “NO” is determined in the step S239, the process returns to the step S235. If “YES” is determined in the step S239, it is determined, in a step S241, whether or not the operating region with which the gaze area overlaps is changed. If “NO” is determined in the step S241, the process proceeds to a step S245. If “YES” is determined in the step S241, in a step S243, the gaze timer 504h is reset and started, and then, the process proceeds to the step S245.

In the step S245, it is determined whether or not a sixth predetermined time period (1-3 seconds, for example) elapses. Here, the processor 40 determines, with referring to the count value of the gaze timer 504h, it is determined whether or not a time that the user gazes at the operating region (410L, 410R, 410T, 410B) reaches the sixth predetermined time period.

If “NO” is determined in the step S245, that is, if the sixth predetermined time period does not elapse, the process returns to the step S235. If “YES” is determined in the step S245, that is, if the sixth predetermined time period elapses, in a step S247 shown in FIG. 24, it is determined whether or not the gaze area is a left. Here, the processor 40 determines whether or not the user gazes at the operating region 410L.

If “YES” is determined in the step S247, that is, if the gaze area is a left, a scroll in the rightward direction at a predetermined amount is performed in a step S249, and then, the process returns to the step S235 shown in FIG. 23. If “NO” is determined in the step S247, that is, if the gaze area is not a left, in a step S251, it is determined whether or not the gaze area is a right. Here, the processor 40 determines whether or not the user gazes at the operating region 410R.

If “YES” is determined in the step S251, that is, if the gaze area is a right, a scroll in the leftward direction at a predetermined amount is performed in a step S253, and then, the process returns to the step S235. If “NO” is determined in the step S251, that is, if the gaze area is not a right, in a step S255, it is determined whether or not the gaze area is a top. Here, the processor 40 determines whether or not the user gazes at the operating region 410T.

If “YES” is determined in the step S255, that is, if the gaze area is the up, the process returns to the 235 after a scroll is performed in the downward direction at a predetermined amount in a step S257. If “NO” is determined in the step S255, that is, in a case that the operating region 410B is gazed at, it is determined that the gaze area is a bottom, and in a step S259, a scroll in the upward direction is performed at the predetermined amount, and then, the process returns to the step S235.

In addition, it is described that the screen can be necessarily scrolled, but if an end of a displaying content is displayed or the last page is displayed, the screen cannot be scrolled, and in such a case, even if an instruction for the scrolling is input, this instruction is ignored.

FIG. 25 and FIG. 26 show a flowchart for an incoming call processing in the step S81 shown in FIG. 16. In the following, this incoming call processing will be described, but processing the same or similar to those of the above-described application selecting process, the e-book processing or the browsing processing is simply described.

As shown in FIG. 25, when the incoming call processing is started, in a step S271, the processor 40 starts an incoming call operation. Here, the processor 40 outputs a ringtone (a phone melody or music), or drives the vibration motor, or performs both of them.

In a next step S273, an incoming call screen 350 shown in FIG. 7 is displayed on the display 14. Next, in a step S275, a detection of a gaze area is started. In a step S277, it is determined whether or not incoming call processing is to be terminated. Here, the processor 40 determines whether or not a longest time (30 seconds, for example) that is set in advance for the incoming call operation elapses or whether or not the other end on the line hangs up.

If “YES” is determined in the step S277, that is, if the incoming call processing is to be terminated, the process proceeds to a step S291 shown in FIG. 26. If “NO” is determined in the step S277, that is, if the incoming call processing is not to be terminated, a gaze area is acquired in a step S279. In a next step S281, it is determined whether or not the gaze area overlaps with the operating region (here, the displaying region of the button image 360 or 362).

If “NO” is determined in the step S281, the process returns to the step S277. If “YES” is determined in the step S281, it is determined, in a step S283, whether or not the operating region with which the gaze area overlaps is changed. If “NO” is determined in the step S283, the process proceeds to a step S287. If “YES” is determined in the step S283, in a step S285, the gaze timer 504h is reset and started, and then, the process proceeds to the step S287.

In the step S287, it is determined whether or not a fifth predetermined time period (1-3 seconds, for example) elapses. Here, the processor 40 determines, with referring to the count value of the gaze timer 504h, whether or not a time that the user gazes at the operating region (the displaying region of the button image 360 or 362) reaches the fifth predetermined time period.

If “NO” is determined in the step S287, that is, if the fifth predetermined time period does not elapse, the process returns to the step S277. If “YES” is determined in the step S287, that is, if the fifth predetermined time period elapses, in a step S289 shown in FIG. 26, it is determined whether or not the gaze area is an incoming call answer. Here, the processor 40 determines whether or not the user gazes at the button image 360.

If “NO” is determined in the step S289, that is, in a case that the user gazes at the button image 362, it is determined that the incoming call is to be stopped, and in the step S291, the incoming call answer is stopped, and then, the process returns to the performing function determination process. In the step S291 (the same as in the step S293), the processor 40 stops the ringtone, or stops the vibration motor, or performs both of them. If “YES” is determined in the step S289, that is, if the incoming call is to be answered, in a step S293, the incoming call answer is stopped, and in a step S295, the above-described telephone conversation processing is performed.

Subsequently, in a step S297, it is determined whether or not the telephone conversation is to be ended. Here, the processor 40 determines whether or not the end key 24 is operated by the user, or an end signal is received from the other end on the line. If “NO” is determined in the step S297, that is, if not to be ended, the process returns to the step S295, to continue the telephone conversation processing. If “YES” is determined in the step S297, that is, if to be ended, in a step S299, the circuit is cut-out and the process returns to the performing function determination process.

According to this embodiment, since the infrared camera is arranged above the display, and the infrared LED is arranged below the display, even in a case that the user slightly closes the eyelid, it is possible to surely image the reflecting light of the infrared light, and thus, it is possible to be increase the recognition rate of the eye-controlled input.

In addition, in this embodiment, only the security lock function is described as the lock function, but not limited thereto. As the lock function, a lock (key lock) function for preventing an erroneous operation of the touch panel may be introduced. One of the security lock function and the key lock function may be settable, or both of them are settable. In addition, in a case that both of the security lock function and the key lock function are set, when the power of the display is turned-on, the security lock is canceled after the key lock is canceled.

In a case that the key lock function is set, when the use of the mobile phone 10 is started, that is, when the power for the display 14 is turned-on, a lock screen 450 (key lock) as shown in FIG. 27 is displayed on the display 14. As shown in FIG. 27, the lock screen 450 includes a displaying area 452 and a displaying area 454. In the displaying area 454, a predetermined object (a circular object, for example) 460 is displayed. In the following, the circular object 460 is called as a cancel object.

In the lock screen 450 shown in FIG. 27, if and when the cancel object 460 is moved equal to or more than a predetermined distance, the lock screen 450 is put out (non-displayed), and a screen (a standby screen or a desired function's screen) at a time that the preceding processing is ended (having been displayed just before the power for the display 14 is turned-off) is displayed on the display 14. In FIG. 27, a circle 470 of a dotted line having a radius (predetermined distance) d with a center at the center 460a of the cancel object 460 is shown; however, in an actual lock screen 450, the circle 470 may be or may not be displayed on the display 14. As a displaying manner in a case that the circle 470 is displayed, not limited to show a contour line with a dotted line, a predetermined color may be applied.

In addition, a movement of the cancel object 460 is performed by an eye-controlled operation. Specifically, when the lock screen 450 is being displayed, if the gaze area and the operating region for the cancel object 460 are overlapped with each other, in accordance with a position change of the gaze area (a line of sight) thereafter, the cancel object 460 is continuously moved.

Then, if the cancel object 460 is moved equal to or more than the predetermined distance d, the lock screen 450 is put out, and the key lock is canceled. For example, if the center 460a of the cancel object 460 is moved onto the contour line of the circle 470 or over the contour line, it is determined that the cancel object 460 is moved equal to or more than the predetermined distance d.

Here, by moving the cancel object 460, the displaying manner is changed, and at a time that the cancel object 460 is moved equal to or more than the predetermined distance d, it is determined that the displaying manner becomes a predetermined manner, and the key lock is canceled, but not limited thereto. For example, an arrangement may be employed such that, by changing a size or a color of the cancel object 460 when the user gazes at the cancel object 460, the displaying manner is changed, and when the size and the color of the cancel object 460 are changed to a predetermined size and a predetermined color, it is determined that the cancel object 460 becomes the predetermined manner, thereby to cancel the key lock. In such a case, when a time that the gaze area overlaps the displaying region (operating region) of the cancel object 460 reaches an eighth predetermined time period (3-5 seconds, for example), the size and the color of the cancel object 460 are changed to the predetermined size and the predetermined color. The size of the cancel object 460 is made larger (or smaller) by a predetermined amount (a predetermined length of a radius) at every unit time (0.5-1 seconds, for example). That is, the cancel object 460 is continuously changed according to the gaze time. Then, when the cancel object 460 becomes the same size as the circle 470, for example, it is determined that the cancel object 460 becomes the predetermined size. Therefore, a predetermined amount (predetermined dot width) by which the size of the cancel object 460 is changed lineally or gradually is set such that the change of the cancel object 460 is ended at a timing that the gaze time is coincident with the eighth predetermined time period. Such a setting is also employed for a case that the color of the cancel object 460 is changed.

The internal color of the cancel object 460 is changed by a predetermined amount at every unit time. Then, when the color of the cancel object 460 is entirely changed, it is determined that the cancel object 460 is changed to the predetermined color. Here, instead of the color of the cancel object 460, a luminance may be changed.

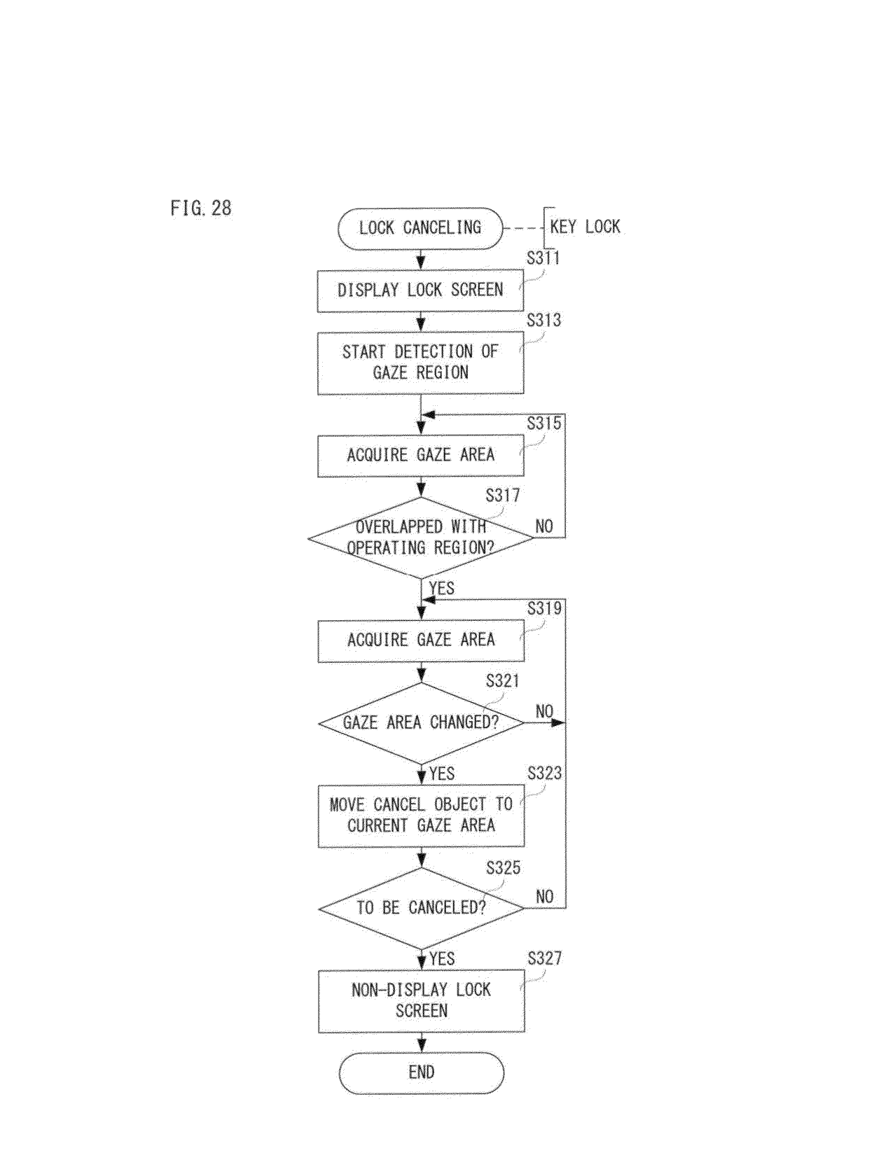

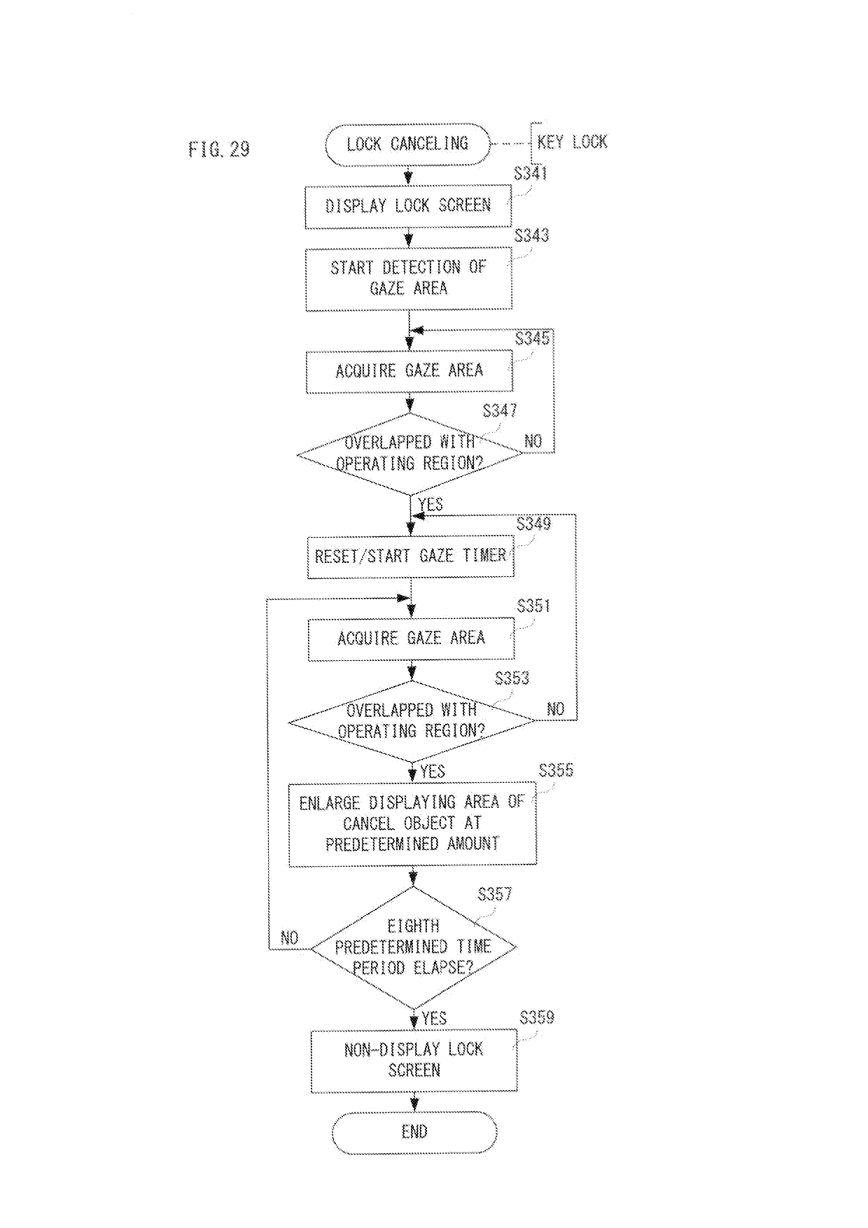

A specific lock canceling process (key lock) is shown in FIG. 28 and FIG. 29. FIG. 28 shows a lock canceling process in a case that the key lock is canceled by moving the cancel object 460 by a line of sight. Furthermore, FIG. 29 is a flowchart for a lock canceling process in a case that the key lock is canceled by gazing at the cancel object 460.

When the lock canceling process is started as shown in FIG. 28, the processor 40 displays a lock screen 450 as shown in FIG. 27 on the display 14 in a step S311. At this time, the operating region is set in correspondence to the displaying region of the cancel object 460, and the corresponding operating region data 504d is stored in the data storage area 504. The lock canceling process is executed at a time that the use of the mobile phone 10 is started, that is, the power for the display 14 is turned-on, in a case that the key lock function is turned-on.

In a next step S313, a detection of a gaze area is started. That is, the processor 40 executes a gaze area detecting process (FIG. 15) in parallel with the lock canceling process. In a succeeding step S315, the gaze area is acquired. The processor 40 acquires a gaze area detected by the gaze area detecting process with reference to the gaze area data 504c. In a next step S317, it is determined whether or not the acquired gaze area overlaps with the operating region. Here, the operating region data 504d is referred to and it is determined whether or not the gaze area previously acquired overlaps with the operating region. If “NO” is determined in the step S317, that is, if the gaze area acquired does not overlap with the operating region, the process returns to the step S315.

On the other hand, if “YES” is determined in the step S317, that is, if the acquired gaze area overlaps with the operating region, in a step S319, the gaze area is acquired, and in a step S321, it is determined whether or not the gaze area is changed. The processor 40 determines whether or not the gaze area detected at this time is different for the gaze area indicated by the gaze area data 504c.

If “NO” is determined in the step S321, that is, if the gaze area is not changed, it is determined that the line of sight is not moved, and the process returns to the step S319. If “YES” is determined in the step S321, that is, if the gaze area is changed, it is determined that the line of sight is moved, and then, in a step S323, the cancel object 460 is moved equal to or to the current gaze area. For example, the processor 40 displays the cancel object 460 in a manner that the center of the gaze area and the center of the cancel object 460 become to be coincident with each other.

In a next step S325, it is determined whether or not the key lock is to be canceled. That is, the processor 40 determines whether or not the cancel object 460 is moved more than the predetermined distance d. If “NO” is determined in the step S325, that is, if the key lock is not to be canceled, the process returns to the step S319. If “YES” is determined in the step S325, that is, if the key lock is to be canceled, the lock screen 450 is put out (non-displayed) in a step S327, and then, the lock canceling process is terminated.

Next, a lock canceling process (key lock) shown in FIG. 29 will be described, but the same steps as those of the lock canceling process shown in FIG. 28 will be simply described. When the lock canceling process is started as shown in FIG. 29, the processor 40 displays a lock screen 450 as shown in FIG. 27 on the display 14 in a step S341. In a next step S343, a detection of a gaze area is started. Subsequently, in a step S345, the gaze area is acquired, and in a step S347, it is determined whether or not the acquired gaze area overlaps with the operating region. If “NO” is determined in the step S347, the process returns to the step S345.

On the other hand, if “YES” is determined in the step S347, the gaze timer 504h is reset and started in a step S349. Subsequently, in a step S351, the gaze area is acquired, and in a step S353, it is determined whether or not the acquired gaze area overlaps with the operating region.

If “NO” is determined in the step S353, the process returns to the step S349. If “YES” is determined in the step S353, in a step S355, a displaying area (size) of the cancel object 460, that is, the length of the radius of the cancel object 460 is made larger (or smaller) at a predetermined amount. Then, in a step S357, it is determined whether or not an eighth predetermined time period (3-5 seconds, for example) elapses. Here, the processor 40 determines whether or not the user gazes at the cancel object 460 more than the predetermined eighth predetermined time period by determining whether or not a count value of the gaze timer 504h reaches the eighth predetermined time period.

If “NO” is determined in the step S357, that is, if the eighth predetermined time period does not elapse, it is determined that the key lock is not to be canceled, and the process returns to the step S351. In addition, in the steps S351-S357, the displaying area of the cancel object 460 is enlarged (or reduced) by the predetermined amount in accordance with the gaze time.

On the other hand, if “YES” is determined in the step S357, that is, if the eighth predetermined time period elapses, it is determined that the key lock is to be canceled, and the lock screen 450 is put out (non-displayed) in a step S359, and the lock canceling process is terminated.

In addition, in the above-described embodiment, the displaying area of the cancel object 460 is changed by gazing at the cancel object 460, but, as described above, the color of the cancel object 460 may be changed.

Furthermore, in the above-described embodiment, during a time that the cancel object 460 is gazed at, the displaying area or the color thereof is changed, but it is not necessary to change the displaying manner of the cancel object 460, and at a timing that the eighth predetermined time period elapses, the key lock may be canceled. In such a case, the processing in the step S355 may be deleted.

The key lock is thus canceled by an eye-controlled operation. If another person intends to cancel the key lock through an eye-controlled operation, the eye-controlled operation by the person cannot be correctly recognized for a reason that the distance L between both of the eyes differs, for example, and therefore, it is possible to prevent the mobile phone 10 from being used by other persons unintentionally. This is true for the cancel of the security lock.

In addition, the embodiment is described that the lock canceling process (key lock) shown in FIG. 28 and FIG. 29 can be executed on the assumption that the eye-controlled operation is usable, but, in fact, it is necessary to perform a calibration previously.

Furthermore, in FIG. 28 and FIG. 29, the key lock is canceled by only the eye-controlled operation; however, instead of the eye-controlled operation, the cancel of the key lock may be performed by the touch operation in a case that there is no eye-controlled operation for more than a predetermined time period from a time that the lock screen 450 becomes to be displayed or in a case that the lock cancel by the eye-controlled operation fails by a predetermined number of times.

Furthermore, in the above-described embodiments, a case that the alarm function of the mobile phone 10 is used as an alarm clock, but the alarm function can be used as an alarm for schedule. In a case that the alarm function is used as the alarm for schedule, if a content of the schedule may be displayed on the display 14 at a time that the alarm is rung or the alarm is stopped, it is possible to make the user surely confirm the content of the schedule.

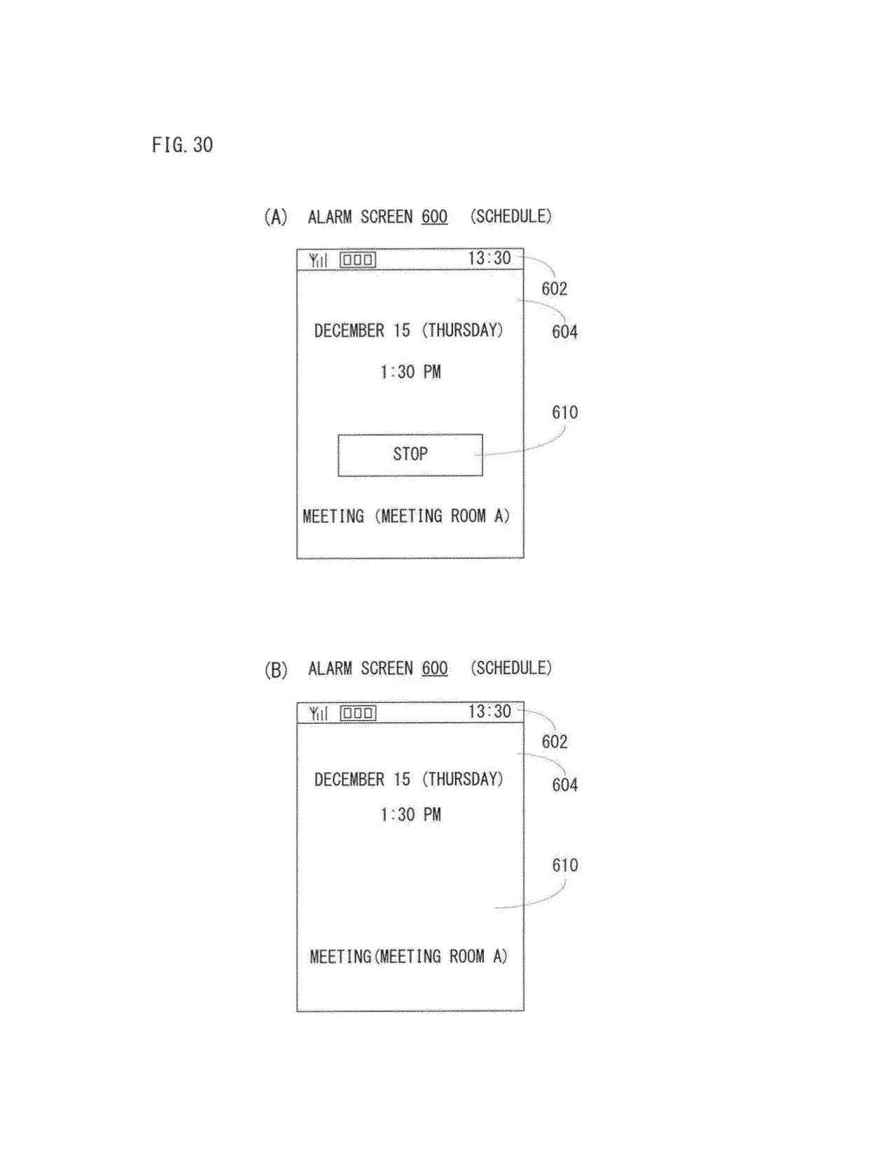

FIG. 30(A) and FIG. 30(B) show examples of an alarm screen 600 for the schedule. The alarm screen 600 is displayed on the display 14 at a time that the alarm is rung upon reaching an alarm time and date for the schedule.

As shown in FIG. 30(A) and FIG. 30(B), the alarm screen 600 includes a displaying area 602 and a displaying area 604. In the displaying area 604, information of month, day, day of week, current time, etc. is displayed, and a button image 610 for stopping the alarm is further displayed. Below the button image 610, a content of the schedule is displayed. In addition, a time (including date) of schedule and the content are registered in advance by performing a scheduling function by the user.

Therefore, in a case that the alarm screen 600 is displayed, by performing an eye-controlled operation by the user, if a time that the button image 610 is gazed at, i.e., a gaze time reaches a ninth predetermined time period (1-3 seconds, for example), the button image 610 is turned-on, whereby the alarm is stopped. As described above, the content of schedule is displayed when the alarm screen 600 is displayed, or when the button image 610 is turned-on.

Furthermore, in the alarm screen 600 shown in FIG. 30(B), a content of schedule is displayed on the button image 610. A method for stopping the alarm by the eye-controlled operation is similar to the method for the alarm screen 600 shown in FIG. 30(A), and is performed by gazing at the button image 610. Therefore, in a case that the alarm screen 600 shown in FIG. 30(B) is displayed, the user can confirm the content of schedule while performing the eye-controlled operation for stopping the alarm.

In addition, in this embodiment shown, the infrared camera and the infrared LED are arranged apart from each other in a vertical direction, but not limited thereto. For example, electronic equipment such as a smartphone may be used in the horizontal direction, and therefore, the structure capable of performing an eye-controlled operation in such a case may be adopted.

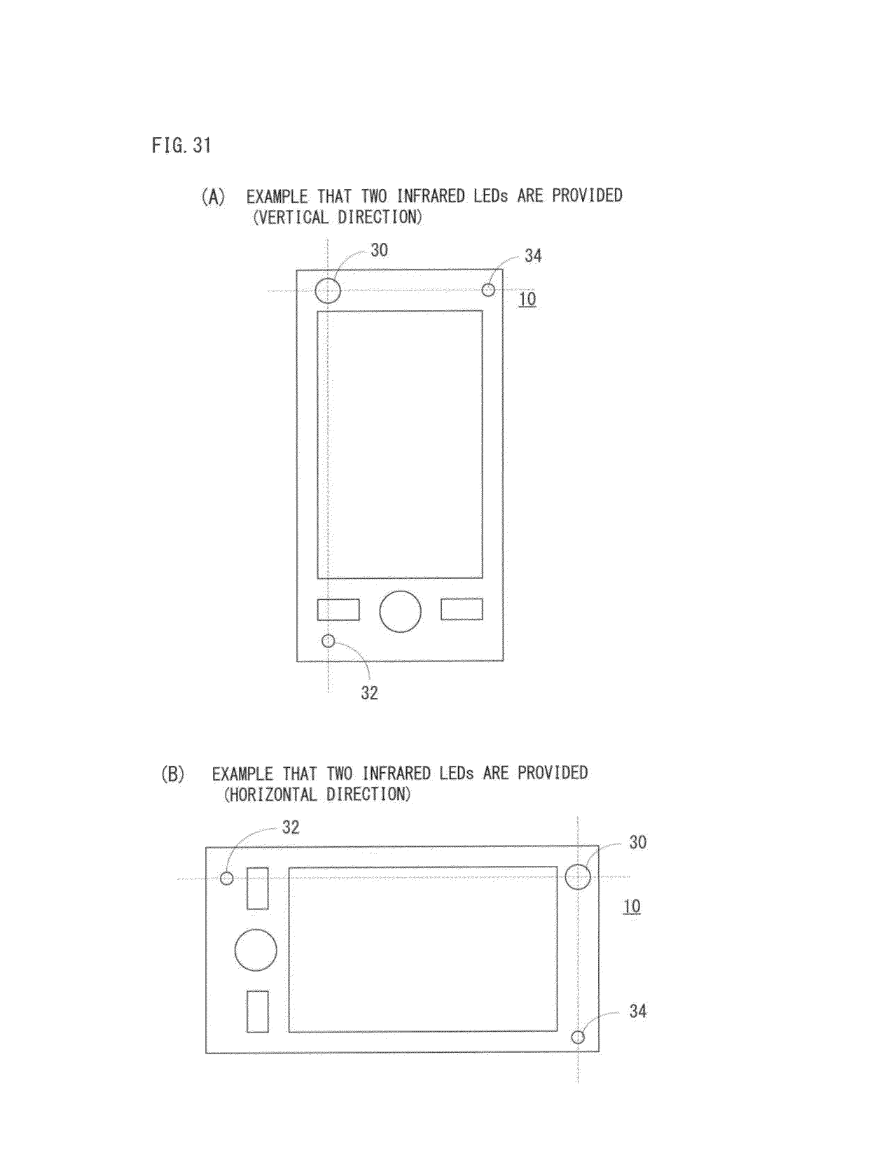

For example, as shown in FIG. 31(A) and FIG. 31(B), in addition to the infrared camera 30 and the infrared LED 32, a further (second) infrared LED 34 is provided. As shown in FIG. 31(A), the infrared LED 34 is arranged above the display 14 and at a right side of the display 14 (an opposite side to the infrared camera 30). Therefore, as shown in FIG. 31(A), in a case that the mobile phone 10 is used in the vertical direction, as described in the above embodiments, the user can perform an eye-controlled operation by detecting a line of sight with using the infrared camera 30 and the infrared LED 32. In a case that the mobile phone 10 is used in the horizontal direction as shown in FIG. 31(B), the user can perform an eye-controlled operation by detecting a line of sight with using the infrared camera 30 and the infrared LED 34. That is, the use of the infrared LEDs (32, 34) is changed according to the direction of the mobile phone 10, the vertical direction or the horizontal direction. Such a direction of the mobile phone 10 is detectable by providing an acceleration sensor, for example. In a case of the horizontal direction, the infrared camera 30 and the infrared LED 34 are arranged at the side of a right eye of the user, and therefore, a gaze area is determined based on the pupil of the right eye and the reflecting light from the right eye. Thus, by providing two infrared LEDs, an eye-controlled operation can be performed in both of the cases of the vertical direction and the horizontal direction without performing complex calculations.

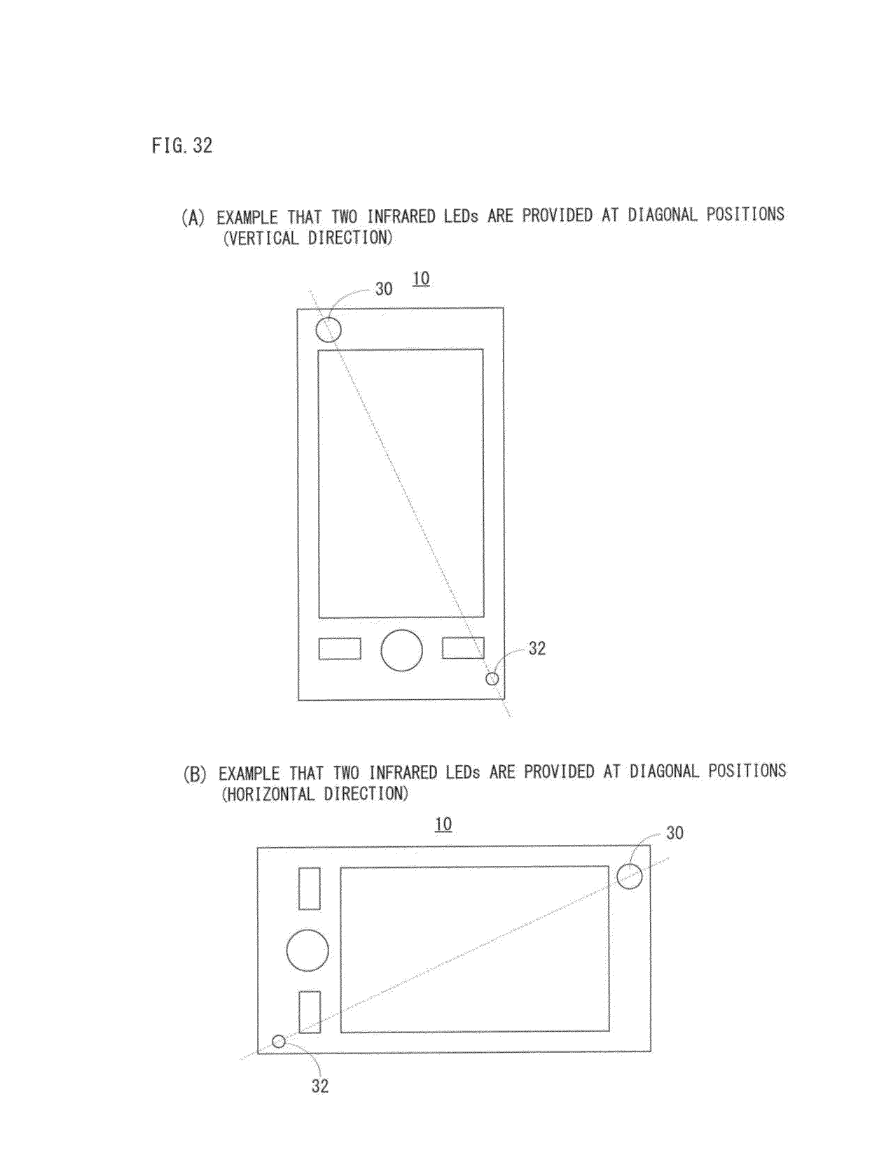

Furthermore, as shown in FIG. 32(A) and FIG. 32(B), for example, the infrared camera 30 and the infrared LED 32 may be arranged on a diagonal line of the display 14; however, the infrared camera 30 may be arranged at a right side of the display 14 and the infrared LED 32 may be arranged at the left side of the display 14. By adopting such structure, an eye-controlled operation can be performed in both of the cases of the vertical direction and the horizontal direction without increasing the number of parts.

In addition, in the embodiment shown, a case that the processing by the processor is performed by the eye-controlled operation, but it is needless to say that such the processing may be performed through a key operation or a touch operation. In addition, when the processing by the eye-controlled operation is performed, a setting may be made so as not to accept the key operation and the touch operation.

Furthermore, in the embodiment shown, a case that the eye-controlled operation can be performed has been described, but, there is a case that the eye-controlled operation (eye-controlled input) can be performed or cannot be performed, and therefore, in a case that the eye-controlled operation can be performed, a message or an image (icon) indicative of such a situation may be displayed. Furthermore, in a case that the eye-controlled operation is being performed, a message or an image to accept the eye-controlled input (during the eye-controlled operation being executed) may be displayed. Thus, the user can recognize that the eye-controlled operation can be performed and that the eye-controlled input can be accepted.

Furthermore, in the above-described embodiments, when the alarm processing, the application selecting processing, the e-book processing, the browsing processing or the incoming call processing is started, the eye-controlled operation is automatically detected, but limited thereto. For example, the eye-controlled operation may be started in response to a predetermined key operation or touch operation. Likewise, the end of the eye-controlled operation may be instructed by a predetermined key operation or touch operation.

Furthermore, in the performing function determination process shown in FIG. 16 and FIG. 17, it is described that the alarm processing, the application selecting processing, the e-book processing, the browsing processing and the incoming call processing are independently performed; however, even if the alarm processing, the application selecting processing, the e-book processing or the browsing processing is being executed, when an incoming call reaches, the incoming call processing may be performed as an interruption.

Therefore, as described above, in a case that the start or the end of the eye-controlled operation is instructed, or in a case that an application or function capable of being performed with the eye-controlled operation and an application or function not capable of being performed with the eye-controlled operation mingles, when the incoming call processing is started as an interruption, whether the eye-controlled operation can be utilized in the incoming call processing may be set depending on whether the eye-controlled operation being performed for an application or function having being executed just before.

For example, in a case that the eye-controlled operation is performed in the application or function having been executed just before, if the incoming call is input, it is possible to instruct to answer or stop the incoming call based on the eye-controlled operation. Inversely, if the incoming call is input, the eye-controlled operation is made unable and only the key operation or the touch operation may be accepted, thereby to instruct to answer or stop the incoming call by the key operation or the touch operation. In such a case, since it does not take a time for the processing that the gaze area is detected or the like, the incoming call can be promptly answered or stopped. Furthermore, in a case that the key operation or touch operation is performed for an application or function having being executed just before, if the incoming call is input, to answer or stop the incoming call may be instructed based on the key operation or touch operation as it is. That is, since an operating method is maintained before and after the incoming call, a burden to change an operating method is removed from the user.

Programs utilized in the above-described embodiments may be stored in an HDD of the server for data distribution, and distributed to the mobile phone 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case that the plurality of programs downloaded via the above-described server or storage medium are installed to a mobile terminal having the structure equal to the structure of the embodiment, it is possible to obtain advantages equal to advantages according to the embodiment.

The specific numerical values mentioned in this specification are only examples, and changeable properly in accordance with the change of product specifications.

An embodiment is electronic equipment provided with a display portion, comprising: an infrared light detecting portion which is arranged above the display portion and detects an infrared light; and a first infrared light output portion which is arranged below the display portion.

In the embodiment, the electronic equipment (10) is provided with a display portion (14). The electronic equipment comprises an infrared light detecting portion (30) which is arranged above the display portion and detects an infrared light and a first infrared light output portion (32) which is arranged below the display portion. Accordingly, the infrared light is irradiated to a portion lower than the center of the pupil of an eye of the user facing straight the display portion of the electronic equipment. Therefore, even in a state that an eyelid of the user is slightly closed, a reflecting light of the infrared light can be imaged by the infrared light detecting portion.

According to the embodiment, since the reflecting light of the infrared light can be surely imaged, a recognition rate of an eye-controlled input can be increased. Therefore, in a case that the electronic equipment is operated by the eye-controlled input, it is possible to surely receive such an operation.

Another embodiment is the electronic equipment wherein the infrared light detecting portion and the first infrared light output portion are arranged on a first line which is in parallel with a vertical direction of the display portion.

In this embodiment, the infrared light detecting portion and the first infrared light output portion are arranged on a first line being in parallel with the vertical direction of the display portion. The infrared light detecting portion and the first infrared light output portion are arranged in a manner that the center position of a detecting surface of the infrared light detecting portion and the center position of an light-emitting surface of the first infrared light output portion are laid on the same line, for example.

According to this embodiment, since the infrared light detecting portion and the first infrared light output portion are arranged on a line, it is unnecessary to perform correcting processing due to a positional deviation of the both. That is, it is unnecessary to perform complicated calculation.

A further embodiment is the electronic equipment further comprising a second infrared light output portion, wherein the second infrared light output portion is arranged on a second line which is in parallel with a horizontal direction of the display portion at an opposite side of the infrared light detecting portion in the horizontal direction of the display portion, the infrared light detecting portion being arranged on the second line.

In the further embodiment, a second infrared light output portion (34) is provided, which is arranged on a second line being in parallel with a horizontal direction of the display portion at an opposite side of the infrared light detecting portion in the horizontal direction of the display portion, the infrared light detecting portion being arranged on the second line. The second infrared light output portion is arranged in a manner that the center position of a detecting surface of the infrared light detecting portion and the center position of a light emitting surface of the second infrared light output portion are laid on the same line, for example. Therefore, if the electronic equipment is used in a traverse direction, by using the infrared light detecting portion and the second infrared light output portion, a direction of a line of sight is detected.

According to the further embodiment, irrespective of a direction of the electronic equipment, a recognition rate of an eye-controlled input can be increased.

A still further embodiment is the electronic equipment wherein the infrared light detecting portion and the first infrared light output portion are arranged at diagonal positions sandwiching the display portion.

In the still further embodiment, the infrared light detecting portion and the first infrared light output portion are arranged at diagonal positions sandwiching the display portion. In a case of a display portion having a rectangular displaying surface, the infrared light detecting portion and the first infrared light output portion are arranged on a line in parallel with a diagonal line. Accordingly, even if the electronic equipment is used vertically or even if the electronic equipment is used horizontally, by using the infrared light detecting portion and the first infrared light output portion, a line of sight can be detected.

According to the still further embodiment, it is possible to detect a line of sight in both directions of the vertical direction and the horizontal direction without increasing of the number of parts.

A yet still further embodiment is the electronic equipment further comprising a gaze area detecting portion which detects a gaze area on a screen of the display portion at which a user is gazing, based on a pupil of the user detected by the infrared light detecting portion and a reflecting light of the first infrared light output portion; and a performing portion which performs predetermined processing based on the gaze area detected by the gaze area detecting portion.

In the yet still further embodiment, the electronic equipment further comprises the gaze area detecting portion (40, 62, S49) and the performing portion (40, S139-S149, S177, S211, S215, S249, S253, S257, S259, S291, S293, S295). The gaze area detecting portion detects a gaze area on a screen of the display portion at which a user is gazing, based on the pupil of the user detected by the infrared light detecting portion and a reflecting light of the first infrared light output portion. For example, in a two-dimension imaged image, an eye vector having a start point at the center position of the reflecting light and an end point at the center position of the pupil is detected, and in accordance with the eye vector, an area on the screen being divided in advance is determined as a gaze area. The performing portion performs predetermined processing based on the gaze area detected by the gaze area detecting portion. For example, a button image, an icon or thumbnail displayed at a position or region overlapping with the gaze area is operated (turned-on), or an operation or action (turning-over pages, scrolling screen, etc.) assigned to a predetermined area (operating region, in embodiments) set at a position or area overlapping with the gaze area is performed.

According to the yet still further embodiment, since the predetermined processing is performed according to an area to which a line of sight of the user is directed, the electronic equipment can be operated by an eye-controlled input.

Another embodiment is the electronic equipment wherein the display portion displays one or more images, and further comprising a displaying manner changing portion which changes, according to a time lapse, a displaying manner of the one or more images with which the gaze area detected by the gaze area detecting portion overlaps.

In the embodiment, the display portion displays one or more images. The image is a button image, an icon, a thumbnail or the like, for example. The displaying manner changing portion changes, according to a time lapse, a displaying manner of the one or more images with which the gaze area detected by the gaze area detecting portion overlaps. For example, a color of a background of the image is changed; a size of a background of the image is changed; or the image is displayed in a predetermined animation (in rotation).

According to this embodiment, since a displaying manner of the image with which the gaze area overlaps, the image recognized by the user to be being gazed can be notified and a passage of gazing time can be notified as a change of the displaying manner.

Another further embodiment is the electronic equipment wherein when the image is changes to a predetermined displaying manner by the displaying manner changing portion, the performing portion performs predetermined processing assigned to the concerned image.

In this further embodiment, the performing portion performs predetermined processing assigned to the concerned image when the image is changes to the predetermined displaying manner. The predetermined displaying manner means, for example, a state that a background color of the image is entirely changed, a state that the image is changed up to a predetermined size or a state that the image is rotated by a predetermined number of rotation.

According to this further embodiment, since if and when the image is changes to a predetermined manner, the performing portion performs the predetermined processing assigned to the concerned image, it is necessary to continue to gaze at the image to some extent, and therefore, it is possible to prevent an erroneous operation.

Another embodiment is the electronic equipment wherein the display portion is set with one or more predetermined regions, and when the gaze area detected by the gaze area detecting portion overlaps any one of the one or more predetermined regions, the performing portion performs predetermined processing assigned to the concerned predetermined region.

In this embodiment, one or more predetermined regions (210, 212, 410L, 410R, 410T, 410B, etc.) is set on the display portion. The performing portion performs the predetermined processing assigned to the concerned predetermined region when the gaze area detected by the gaze area detecting portion overlaps any one of the one or more predetermined regions.

According to this embodiment, even in a case that the image is not displayed, it is possible to set the predetermined region(s) and perform the predetermined processing by gazing at any one of the predetermined region(s).

A further embodiment is the electronic equipment wherein the predetermined processing includes a turning of a page.

In the further embodiment, the predetermined processing includes a turning of the page, the page is advance or returned one by one page basis. The predetermined processing may be the turning to the last page or the first page.

According to the further embodiment, the turning of page(s) can be designated by the eye-controlled operation.

A still further embodiment is the electronic equipment wherein the predetermined processing includes a scroll of a screen.

In the still further embodiment, the predetermined processing is a scroll of the screen, and the screen is scrolled in the leftward or rightward direction or the upward or downward direction, or in the oblique direction.

According to the still further embodiment, the scroll of the screen can be designated by the eye-controlled operation.

A yet still further embodiment is the electronic equipment wherein the display portion displays a lock screen which includes a character or image, further comprising: an arrangement detecting portion which detects according to a time series an arrangement of the character or image with which the gaze area detected by the gaze area detecting portion overlaps; and a lock canceling portion which puts out the lock screen when a predetermined arrangement is included in the arrangement of the character or image detected by the arrangement detecting portion.

In the yet still further embodiment, the lock screen (100) including a character or image is displayed on the display portion. In a case that the security lock function is turned-on, for example, in starting the use of the electronic equipment or in performing (starting) a predetermined application or function, the lock screen is displayed. The arrangement detecting portion (40, S13) detects according to a time series an arrangement of the character or image with which the gaze area detected by the gaze area detecting portion overlaps. That is, the characters or images designated by the eye-controlled input are detected according to an order of the eye-controlled input. The lock canceling portion (40, S19) puts out the lock screen when a predetermined arrangement is included in the arrangement of the character or image detected by the arrangement detecting portion, at a time that “YES” is determined in the step S13, for example.

According to the yet still further embodiment, since the lock canceling can be performed by the eye-controlled operation, even if a situation that the secret code number or the like is input is seen by other person, the other person cannot easily know the secret code number. That is, it is possible to increase the security.

A still further embodiment is the electronic equipment wherein the display portion displays a lock screen which includes a predetermined object, further comprising: a displaying manner changing portion which changes a displaying manner of the predetermined object when the gaze area detected by the gaze area detecting portion overlaps with the predetermined object; and a lock canceling portion which puts out the lock screen when a displaying manner which is changed by the displaying manner changing portion is a predetermined displaying manner.

In the still further embodiment, the lock screen (450) including a predetermined object (460) is displayed on the display portion. In a case that the lock function for the key (touch panel) is turned-on, for example, when the power for the display portion is turned-on, the lock screen is displayed. The displaying manner changing portion (40, S323, S355) changes a displaying manner of the predetermined object when the gaze area detected by the gaze area detecting portion overlaps with the predetermined object. For example, according to the eye-controlled input, the predetermined object is moved, or changed in its size and/or color. The lock canceling portion (40, S327, S359) puts out the lock screen when the displaying manner which is changed by the displaying manner changing portion becomes the predetermined displaying manner (“YES” in S325, S357).

According to the still further embodiment, since the lock canceling can be performed by the eye-controlled operation, it is possible to cancel the lock state even in a situation that the user cannot use his/her hand therefor.

Another embodiment is the electronic equipment wherein the display portion displays a lock screen which includes a predetermined object, and further comprising a lock canceling portion which puts out the lock screen when a time that the gaze area detected by the gaze area detecting portion is overlapping with the predetermined object reaches a predetermined time period.

In this embodiment, the lock screen (450) including the predetermined object (460) is displayed on the display portion. In a case that the lock function for the key (touch panel) is turned-off, for example, when the power for the display portion is turned-on, the lock screen is displayed. The lock canceling portion (40, S359) puts out the lock screen when a time that the gaze area detected by the gaze area detecting portion is overlapping with the predetermined object reaches a predetermined time period (“YES” in S357).

According to this embodiment, it is possible to cancel the lock state even in a situation that the user cannot use his/her hand therefore.

A further embodiment is the electronic equipment wherein the display portion displays at least an alarm screen for stopping an alarm when at a time of alarm, and the performing portion stops the alarm when the gaze area detected by the gaze area detecting portion overlaps with a predetermined area continuously more than a predetermined time period.

In the further embodiment, at least the alarm screen (250, 600) for stopping an alarm is displayed on the display portion when at a time of an alarm. The performing portion stops the alarm when the gaze area detected by the gaze area detecting portion overlaps a predetermined area (260, 262, 610) continuously more than a predetermined time period.

According to the further embodiment, since the alarm can be stopped by the eye-controlled operation, in a case that the electronic equipment is used as an alarm clock, the user necessarily open his/her eyes, it is possible to play a role of the alarm clock suitably. Furthermore, in a case that the electronic equipment is functioned as an alarm for schedule, by displaying the content of schedule on the display, it is possible to make the user confirm the content of schedule surely.

The other embodiment is the electronic equipment further comprising a telephone function, wherein the display portion displays at a time of incoming call, a selection screen which includes at least two predetermined regions to answer an incoming call and to stop the incoming call, and when the gaze area detected by the gaze area detecting portion overlaps with either one of the two predetermined areas continuously more than a predetermined time period, the performing portion answers the incoming call or stops the incoming call in accordance with the concerned predetermined area.

In the other embodiment, the electronic equipment comprises the telephone function. The electronic equipment is a mobile phone, for example. At a time of incoming call, the selection screen (350) which includes at least two predetermined regions to answer an incoming call or to stop the incoming call. When the gaze area detected by the gaze area detecting portion overlaps with either one of the two predetermined areas continuously more than a predetermined time period, the performing portion answers the incoming call or stops the incoming call (refusing the incoming call) in accordance with the concerned predetermined region.

According to the other embodiment, it is possible to answer or stop the incoming call by the eye-controlled operation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Electronic equipment provided with a display portion, comprising:
an infrared light detecting portion which is arranged above the display portion and detects an infrared light; and
a first infrared light output portion which is arranged below the display portion.

2. The electronic equipment according to claim 1, wherein the infrared light detecting portion and the first infrared light output portion are arranged on a first line which is in parallel with a vertical direction of the display portion.

3. The electronic equipment according to claim 2, further comprising a second infrared light output portion, wherein
the second infrared light output portion is arranged on a second line which is in parallel with a horizontal direction of the display portion at an opposite side of the infrared light detecting portion in the horizontal direction of the display portion, the infrared light detecting portion being arranged on the second line.

4. The electronic equipment according to claim 1, wherein the infrared light detecting portion and the first infrared light output portion are arranged at diagonal positions sandwiching the display portion.

5. The electronic equipment according to claim 1, further comprising:
a gaze area detecting portion which detects a gaze area on a screen of the display portion at which a user is gazing, based on a pupil of the user detected by the infrared light detecting portion and a reflected light of the first infrared light output portion; and
a performing portion which performs predetermined processing based on the gaze area detected by the gaze area detecting portion.

6. The electronic equipment according to claim 5, wherein the display portion displays one or more images, further comprising a displaying manner changing portion which changes, according to a time lapse, a displaying manner of the one or more images with which the gaze area detected by the gaze area detecting portion overlaps.

7. The electronic equipment according to claim 6, wherein when the image is changes to a predetermined displaying manner by the displaying manner changing portion, the performing portion performs predetermined processing assigned to the concerned image.

8. The electronic equipment according to claim 5, wherein the display portion is set with one or more predetermined regions, and when the gaze area detected by the gaze area detecting portion overlaps with any one of the one or more predetermined regions, the performing portion performs predetermined processing assigned to the concerned predetermined region.

9. The electronic equipment according to claim 8, wherein the predetermined processing includes a turning of a page.

10. The electronic equipment according to claim 8, wherein the predetermined processing includes a scroll of a screen.

11. The electronic equipment according to claim 5, wherein the display portion displays a lock screen which includes a character or image, further comprising:
an arrangement detecting portion which detects, according to a time series, an arrangement of the character or image with which the gaze area detected by the gaze area detecting portion overlaps; and
a lock canceling portion which puts out the lock screen when a predetermined arrangement is included in the arrangement of the character or image detected by the arrangement detecting portion.

12. The electronic equipment according to claim 5, wherein the display portion displays a lock screen which includes a predetermined object, further comprising:
a displaying manner changing portion which changes a displaying manner of the predetermined object when the gaze area detected by the gaze area detecting portion overlaps with the predetermined object; and
a lock canceling portion which puts out the lock screen when a displaying manner which is changed by the displaying manner changing portion is a predetermined displaying manner.

13. The electronic equipment according to claim 5, wherein the display portion displays a lock screen which includes a predetermined object, further comprising a lock canceling portion which put out the lock screen when a time that the gaze area detected by the gaze area detecting portion is overlapping with the predetermined object reaches a predetermined time period.

14. The electronic equipment according to claim 5, wherein the display portion displays at least an alarm screen for stopping an alarm when at a time of an alarm, and
the performing portion stops the alarm when the gaze area detected by the gaze area detecting portion overlaps with a predetermined area continuously more than a predetermined time period.

15. The electronic equipment according to claim 5, further comprising a telephone function, wherein
the display portion displays at a time of incoming call, a selection screen which includes at least two predetermined regions to answer an incoming call or to stop the incoming call, and
when the gaze area detected by the gaze area detecting portion overlaps with either one of the two predetermined areas continuously more than a predetermined time period, the performing portion answers the incoming call or stops the incoming call in accordance with the concerned predetermined region.
